(19) United States
(12) Patent Application Publication
(10) Pub. No.: US 2013/0125643 A1
(43) Pub. Date: May 23, 2013

(54) Thermal Pulse Flow Meter

(71) Applicant: Utah State University, North Logan, UT (US)

(72) Inventors: J. Clair Batty, North Logan, UT (US); Blake Rusch, Hyde Park, UT (US); David A. Bell, Farmington, UT (US)

(73) Assignee: Utah State University, North Logan, UT (US)

(21) Appl. No.: 13/681,080

(22) Filed: Nov. 19, 2012

Related U.S. Application Data
(60) Provisional application No. 61/561,042, filed on Nov. 17, 2011.

(51) Int. Cl. G01F 1/692

(52) U.S. Cl. CPC G01F 1/692
USPC 73/204.14

(57) ABSTRACT

An apparatus and method are disclosed for using a thermally active device as a flow meter. The flow meter may have an extremely low mass, rapid response time, and use minimal energy. The flow meter may be located near a flow-side surface of a conduit wall, flush with the surface of a wall, or within a boundary layer of a flow in a conduit. In these locations, the device may present virtually no obstruction to the flow. In certain embodiments, the device may use a resistance temperature device (RTD) heated by a known current, and then tested for resistance at a comparatively much lower (nominally zero) value. A flow rate may be calculated as a function of temperature measurements taken at different steady-state conditions. Flow rates may be so measured at any desired frequency, including very infrequently, such as seconds, minutes, or days apart.

### RELATED APPLICATIONS

This application claims priority to U.S. Provisional Patent Application No. 61/561,042, entitled THERMAL PULSE FLOW METER, filed on Nov. 17, 2011, which is incorporated herein by reference in its entirety.

### TECHNICAL FIELD

This invention relates to flow meters and, more particularly, to novel systems and methods for using heat transfer characteristics for measuring a flow rate of a fluid.

### BACKGROUND

As populations increase in water-short areas, efforts to conserve and better use water resources may intensify. This may necessitate closer monitoring and control of water flows used to maintain golf courses, lawns, as well as sprinkler irrigated agriculture. Certain propeller-type flow meters are relatively expensive. Moreover, they include moving parts that may fail or become blocked. Accordingly, what is needed is a low cost, easily incorporated, durable, low-maintenance, flow meter.

### SUMMARY

The present disclosure in aspects and embodiments addresses these various needs and problems by providing a flow meter that may have little or no obstruction to a fluid flow in a conduit.

In embodiments, a flow meter may include a probe configured to fit in an aperture of a conduit, the conduit configured to transmit a fluid flow and having a flow-side surface; a temperature sensor configured to measure a first steady-state temperature of the probe; a heating element configured to heat the probe to a second steady-state temperature of the probe; and a processor configured to calculate a rate of the fluid flow as a function of the first and second steady-state temperatures. A flow meter may further include a boundary layer at the flow-side surface; and wherein the probe is located in the boundary layer. Alternatively, the probe has a probe surface and the probe surface and the flow-side surface of the conduit form a flow surface that is substantially smooth and continuous.

In another embodiment, a flow meter may include a plug face with the probe embedded therein, the plug having a face; and wherein the plug face is contiguous and continuous with the flow-side surface across the aperture.

In another embodiment, the plug may form part of a mount, the mount having an indicator showing a location of the plug face relative to the flow-side surface of the conduit; and the probe is located such that the indicator shows the location of the plug face as contiguous and continuous with the flow-side surface.

A flow meter may further include a current configured to measure the probe temperature and heat the probe to the second steady-state temperature. In another embodiment, the temperature sensor is configured to measure a transient temperature of the probe as the probe is heated and the processor is configured to correlate a time to the transient temperature and calculate the rate of the fluid flow as a function of the transient temperature and time. In embodiments, the temperature sensor and the heating element may be a thin-film resistive temperature device.

In embodiments, the flow meter may be further configured to receive a current, the current effective to provide an indication of the probe temperature and maintain the probe temperature effectively at an unheated temperature.

In another embodiment, a flow meter may include a probe configured to fit in an aperture of a conduit, the conduit having a flow-side surface and configured to transmit a fluid flow; a temperature sensor configured to measure a probe temperature; a heating element configured to pulse heat the probe over a time period in response to a current flow through the probe; and a processor configured to calculate a rate of the fluid flow in the conduit as a function of the temperature of the probe, the current flow, and the time period.

In other embodiments, a method is described, including providing a fluid flow in a conduit, the conduit having a flow-side surface; locating a probe in the fluid flow, the probe having an electrical connection effective to measure a probe temperature; measuring a first steady-state temperature of the probe; heating the probe to a second steady-state temperature; measuring the second steady-state temperature of the probe; and calculating a rate of fluid flow as a function of the first and second steady-state temperatures.

In embodiments, the fluid flow forms a boundary layer at the flow-side surface and locating the probe in the fluid flow includes locating the probe in the boundary layer. In another embodiment, the probe has a probe surface and the probe surface and the flow-side surface of the conduit form a flow surface that is substantially smooth and continuous.

A method may further include providing an aperture in the conduit; providing a plug with the probe embedded therein, the plug having a face; wherein the plug face is contiguous and continuous with the flow-side surface across the aperture. In another embodiment, the plug forms part of a mount and the mount has an indicator showing a location of the plug face relative to the flow-side surface of the conduit; and locating the probe in the fluid flow comprises positioning the probe such that the indicator shows the location of the plug face as contiguous and continuous with the flow-side surface.

Heating the probe to the second steady-state temperature may include passing a current through the probe, the current effective to measure the probe temperature and heat the probe to the second steady-state temperature. In another embodiment, the method may further include measuring a temperature rise profile as the probe is heated to the second steady-state temperature; and calculating the rate of fluid flow as a function of the temperature rise profile. Alternatively, a method may include cooling the probe from the second steady-state temperature to a cooler temperature; measuring a temperature decay profile as the probe cools; and calculating the rate of fluid flow as a function of the temperature decay profile.

In another embodiment, a resistance temperature device is configured to self-heat and measure the temperature of the probe in response to a current flowing through the probe. In embodiments, measuring the first steady-state temperature of the probe may include passing a current through the probe, the current configured to provide an indication of the probe temperature and maintain the probe temperature effectively at an unheated temperature.

### BRIEF DESCRIPTION OF THE DRAWINGS

FIG. 1 is a front elevation view of one embodiment of a flow meter in accordance with the present invention;

FIG. 2 is a cut-away side elevation view thereof;

FIG. 3 is a cut-away side elevation view of an alternative embodiment of a flow meter, having no intrusion into the lumen of the flow conduit;

FIG. 4 is a cut-away side elevation view of another embodiment of a flow meter, also showing control and monitoring by a computer;

FIG. 5 is a two-dimensional graph illustrating a typical temperature-time response for a small metal plate (e.g., mass, slug, sink, heated element) exposed to moving water;

FIG. 6 is a three-dimensional graph illustrating a convective heat transfer coefficient as a function of free-stream water temperature and velocity for flow over a heated flat plate.

FIG. 7 is a perspective view of one embodiment of a probe having both a heat source and sensor in a single element in accordance with the present invention;

FIG. 8 is a perspective thereof installed within a flush mount, to be non-intrusive with respect to the flow, in accordance with the present invention;

FIG. 9 is a partially cutaway, perspective view of one embodiment of the probe and mount in a threaded embodiment for simple installation;

FIG. 10 is an exploded, perspective view of details of one embodiment of the probe with surrounding potting material stabilizing the substrate and sensor;

FIG. 11 is a schematic diagram of one embodiment of a bridge and sensor for a probe arranged for use;

FIG. 12 is a cut-away front elevation view of the mount and probe installed within a conduit in accordance with the present invention;

FIG. 13 is a top plan view thereof;

FIG. 14 is a close-up, cut-away front elevation view thereof;

FIG. 15 is a plot comparing current, change in temperature, and voltage to time for one embodiment of a probe in accordance with the present invention where the probe is permitted to reach a steady-state temperature;

FIG. 16 is a plot comparing current, change in temperature, and voltage to time for one embodiment of a probe in accordance with the present invention where the probe is not permitted to reach a steady-state temperature;

FIG. 17 is a perspective view of an alternative embodiment of a mount, probe, and conduit in accordance with the present invention, the mount being configured as a saddle;

FIG. 18 is another perspective view thereof;

FIG. 19 is a perspective view thereof;

FIG. 20 is another perspective view thereof;

FIG. 21 is a side elevation view thereof;

FIG. 22 is a top plan view thereof;

FIG. 23 is a front elevation view thereof;

FIG. 24 is a perspective view of one embodiment of an integrated system for monitoring flow within a conduit in accordance with the present invention;

FIG. 25 is a graph providing a sample calibration curve for one embodiment of a flow meter in accordance with the present invention.

FIG. 26 is a cutaway, perspective view of one embodiment of a conduit provided with multiple sensors in accordance with the invention;

FIG. 27 is a schematic block diagram of one embodiment of a probe electrical element in a circuit for powering and measuring responses of the probe;

FIG. 28 is a schematic block diagram of a process for controlling and reading a sensor in accordance with the invention;

FIG. 29 is a temperature curve showing the response of a sensor in accordance with one embodiment of the invention;

FIG. 30 is a chart of equations defining the temperature and power performance of the sensor system thereof;

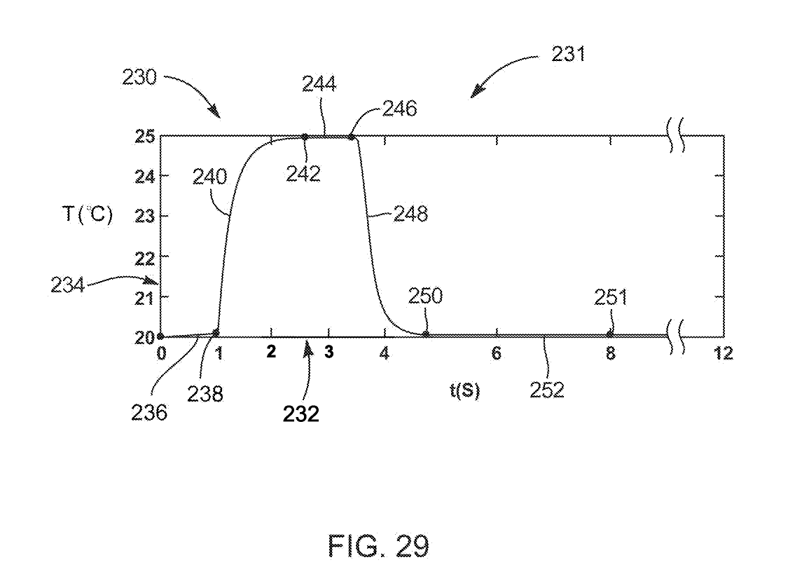

FIG. 29 is a chart of empirical equations characterizing the properties of water as functions of temperature;

FIG. 32 is a schematic block diagram of a process for adjusting a voltage applied to the sensor;

FIG. 33 is a chart of equations characterizing a volumetric flow rate in a conduit as a function of measured characteristics of the flow;

FIG. 34 is a chart of calibration variables; and

FIG. 35 is a chart showing the nomenclature of terms in the example calibration with water.

### DETAILED DESCRIPTION

The present disclosure covers apparatuses and associated methods for a flow meter. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional,” “optionally,” or “or,” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

The present disclosure covers methods, devices, and systems for a thermal-pulse flow meter. It will be readily understood that the components of the present disclosure, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings.

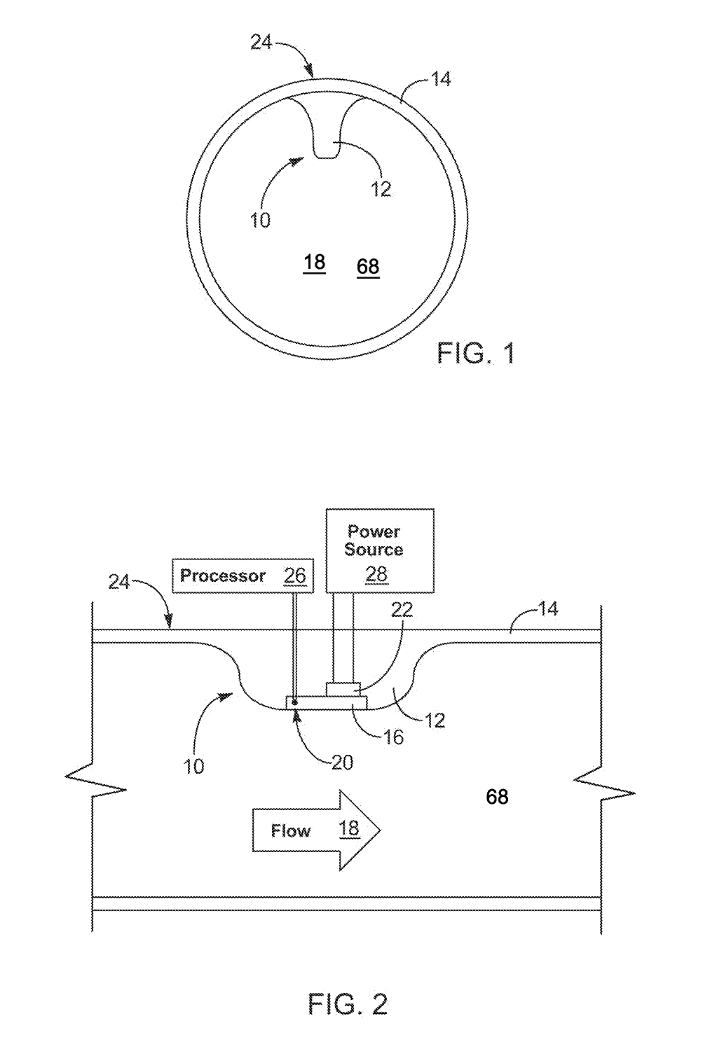

Referring to FIGS. 1 and 2, a flow meter 10 may include a flow divider or an extension 12 extending from a conduit wall 14 of a conduit 24 into (e.g., radially or down into) a free stream of a fluid. The conduit 24 may be any shape suitable to conduct a fluid flow. The conduit 24 may be circular, square, v-shaped, polygon-shaped, or open.

The extension 12, it may extend into the flow 18 with minimal influence thereon. In certain embodiments, a flow meter 10 may include a plate 16 (e.g., a mass, slug, or the like) placed on a radially inward surface (an inward extreme) of the extension 12. The plate 16 may extend parallel to the flow 18. The flow meter 10 may also include a thermocouple 20, RTD 20, or other sensor 20 configured to the monitor the temperature of the plate 16 and a heating element 22 connected to deliver heat to the plate 16. In an RTD configuration, the measurement device and heating element may be one and the same.

The sensor 20 may be monitored to determine the amount of fluid flow 18, based on heat applied by the heating element 22, temperature, and thus the cooling rate. Flow 18 may be calculated based on convection heat transfer and fluid correlations described below.

The flow calculations may be done dynamically based on appropriate heat transfer and fluid dynamics correlations using the properties of the fluid at a known, undisturbed temperature, obtained from the sensor 20 at its unheated and heated temperatures. Alternatively, the determination of velocity may be based on a lookup table providing mapping of empirical data collected over various temperatures, flow rates, material properties, and the like found in heat transfer correlations and applicable to a particular flow meter 10 physical embodiment as calibrated.

In selected embodiments, a flow meter 10 in accordance with the present invention may include a heating element 22 embedded in a metal plate 16. In certain embodiments, the plate 16 may be surrounded on all surfaces but one by an insulating material. In selected embodiments, the insulating material may form an extension 12 holding the plate 16 in the free stream of the flow 18 or lumen 68 of the conduit 24.

In certain embodiments, the plate 16 may be placed away from the wall 14 of the conduit 24 so as to be exposed to fluid in the core of the velocity profile rather than the slower moving boundary layer of fluid near the conduit wall 14. In embodiments, locating the plate 16 in the fluid flow 18 may mean locating the plate 16 in the lumen 68, where the flow is more developed. The extension 12 may be fluid-dynamically smooth so as to minimize flow disturbance or restriction and to allow any debris in the flow 18 to pass by without hanging up on the meter 10 structure.

The plate 16 may be connected to a heating element 22, temperature sensor 20, electronic wiring, control circuitry (e.g., processor 26), and power source 28. The plate 16, heating element 22, and temperature sensor 20 may be embedded in the wall 14 of an otherwise standard pipe fitting, valve, fixture, pipe, or other carrier, such that the non-insulated metal surface of plate 16 would be exposed to the flow 18.

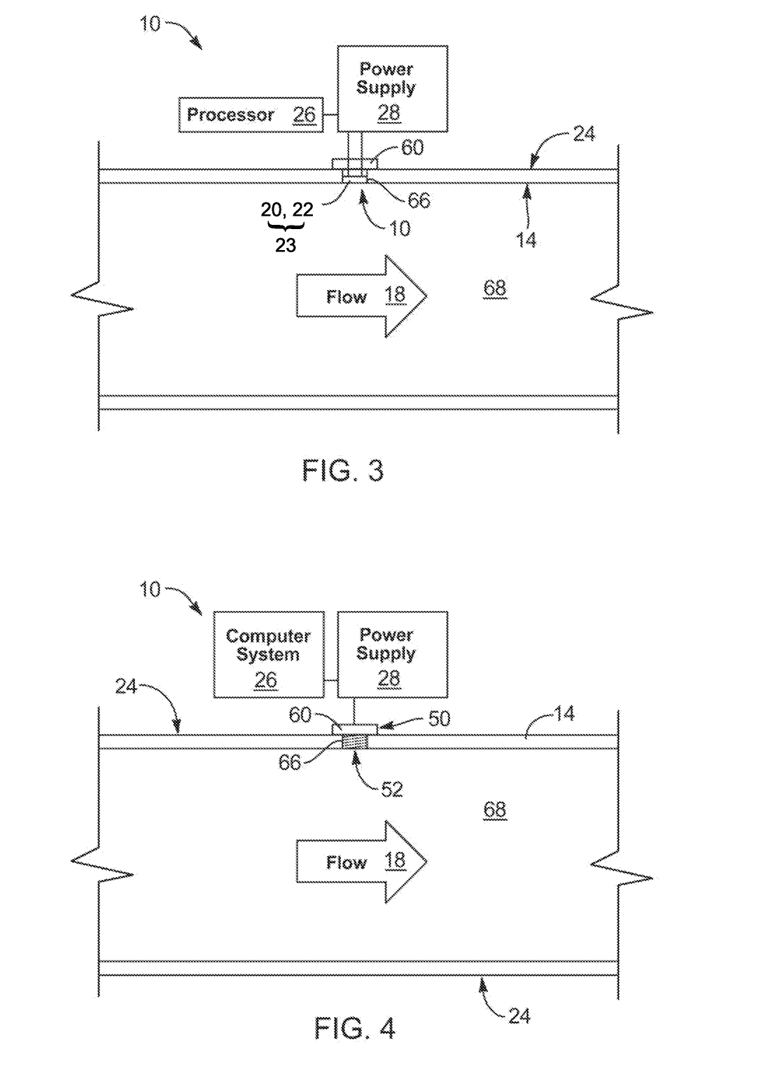

Referring to FIG. 3, a conduit 24 having a wall 14 may conduct a flow 18 through the lumen 68. In the illustrated embodiment, a flow meter 10 may be installed in the wall 14 by means of a mount 60 penetrating the wall 14 through an aperture 66 to place a sensor 20 substantially flush with the wall 14 of the conduit 24.

In the illustrated embodiment, a power supply 28 is controlled by a processor 26 in order to heat the combined heating and sensing element 23. That is, in the illustrated example, a sensor 20 and a heating element 22 may be combined in a single unitary element 23 that receives heating and likewise is probed for temperature readings.

The power supply 28 may contain more than one voltage source, current source, or both. Accordingly, a comparatively very low power may be applied in order to sense temperature through the unit 23, while a comparatively much higher power source may be used to both heat and sense the temperature of the element 23. Meanwhile, a processor 26 may be responsible to control the power source 28 while also processing the data retrieved.

The system 10 may be designed and installed to cause no intrusion into the flow. Accordingly, the combined unit 23 that provides heating and sensing may be in the wall and thus at the fluid boundary, or within the boundary layer at the wall 14 of the conduit 24. In embodiments, locating the sensing element 23 in the fluid flow 18 may include locating the sensing element 23 within the boundary layer at the wall 14 or contiguous and continuous with the wall 14. A sensing element 23 that is contiguous and continuous may be flush with the wall 14 such that the sensing element 23 and wall 14 form a surface that is substantially smooth and continuous in the direction of flow 18.

Referring to FIG. 4, in certain embodiments, a computer system 10 may control a power supply 28 in order to power and read a sensor 52 substantially exposed to the flow 18 in the lumen 68 of a conduit 24. In this embodiment, the lines connecting the power supply 28 to the mount 60 of the probe 50 may be thought of as one or more electrical wires, cables, or other connections effective to transmit information, power, control signals, or combinations thereof to effect the same.

Meanwhile, the line connecting a computer system to the power supply 28 may be thought of as a communication connection providing for commands from a computer system to the power supply 28. Data returns by way of independent feedback, sensing, or the lines from the power supply 28 to the computer system 10. Similarly, data from the probe 50 may be passed back through the power supply 28 or other connections in the physical box that houses the power supply 28, eventually passing back to the computer system 10 for processing.

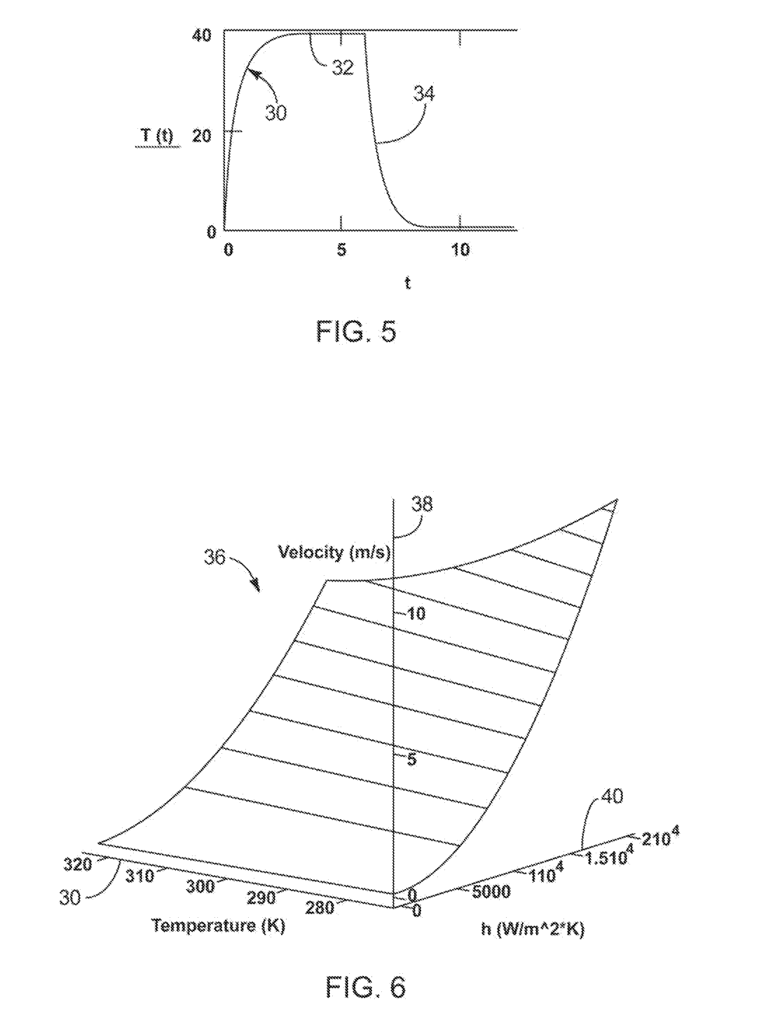

Referring to FIGS. 5 and 6, and the embodiment of FIG. 2, at appropriate intervals, an electrical power pulse may energize the heating element 22 at a known rate, current flow, or duration, and the temperature 30 (or temperature rise profile 30) of the slug or plate 16 (slug, plate, sink, or heated element may be used herein to reflect this element 16) may rise accordingly at a rate that depends on the fluid properties of the contact fluid, including velocity. The maximum temperature 32 attained by the plate 16 may also be a function of contact fluid properties, including both material properties and velocity. For example, the temperature rise profile 30 of the plate 16 may be expressed in terms of the convective heat transfer coefficient, which is, in turn, a function of free stream fluid temperature and fluid velocity.

After the power is shut off, the temperature 30 of the plate 16 may decline along a decay slope 34 at a rate that is also a function of the material properties and velocity of the contact fluid. Thus, the temperature response of the plate 16 following a single power pulse of short duration may provide three separate indicators of the velocity of the fluid at the contact surface: (1) the temperature rise profile 30 as the plate 16 is heated, (2) the maximum steady-state temperature of the plate 16, or the temperature decay slope 34 after the power is shut off. The velocity profile across the fluid conduit may then be deduced, calculated, predicted, or calibrated based on the known position of the plate 16 and the velocity measured at that location. The flow rate may then be calculated from the velocity profile in a chart 36 relating velocity 38 as a function of heat input 40 and temperature 30 of the plate 16.

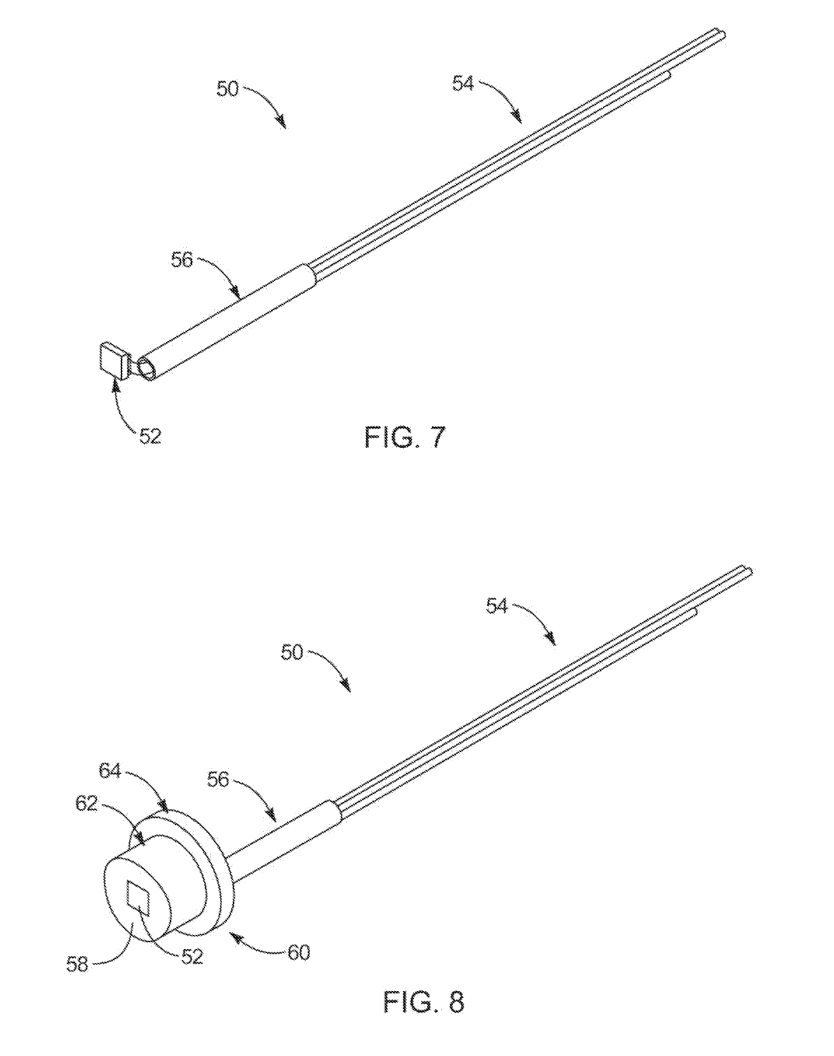

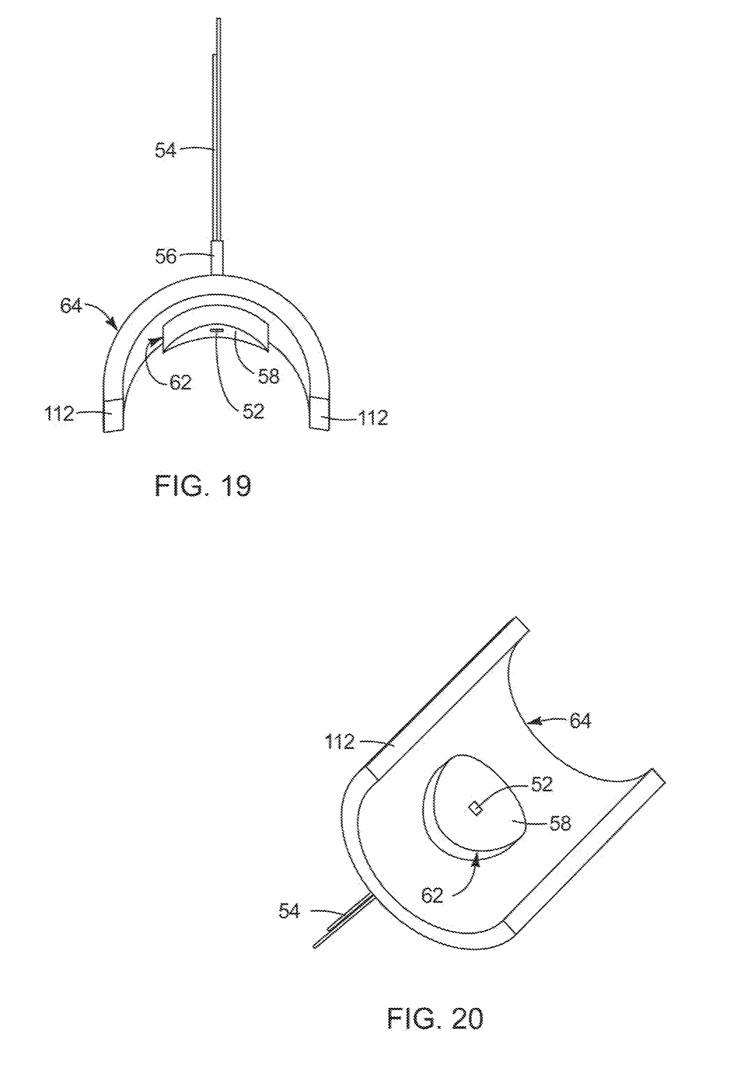

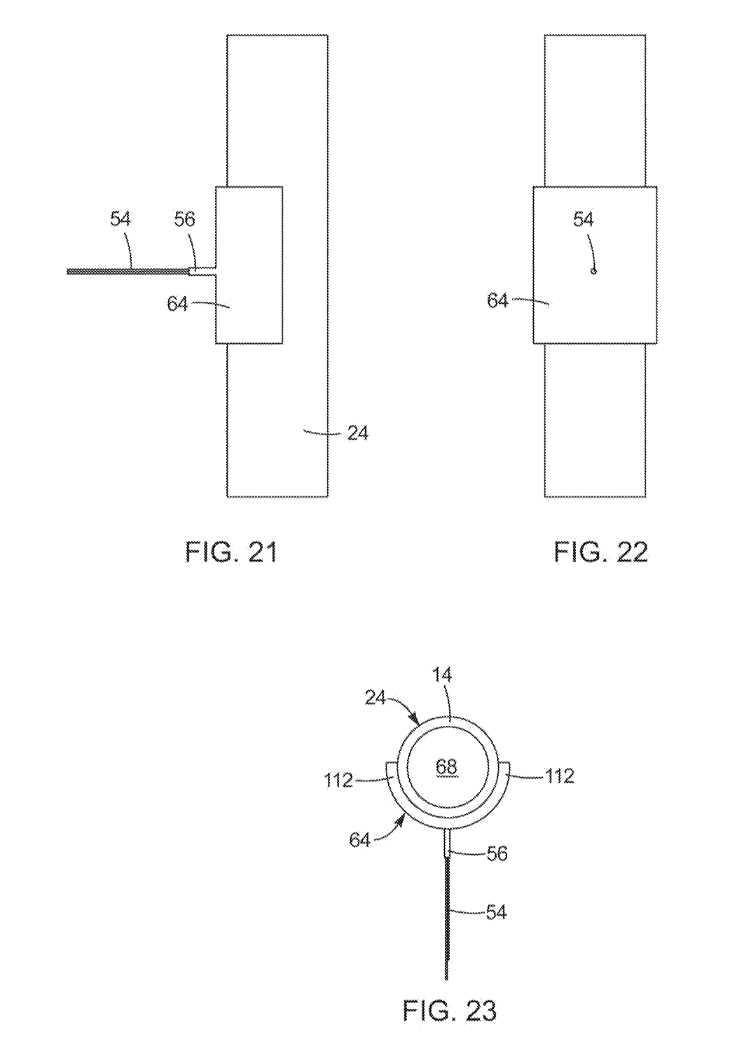

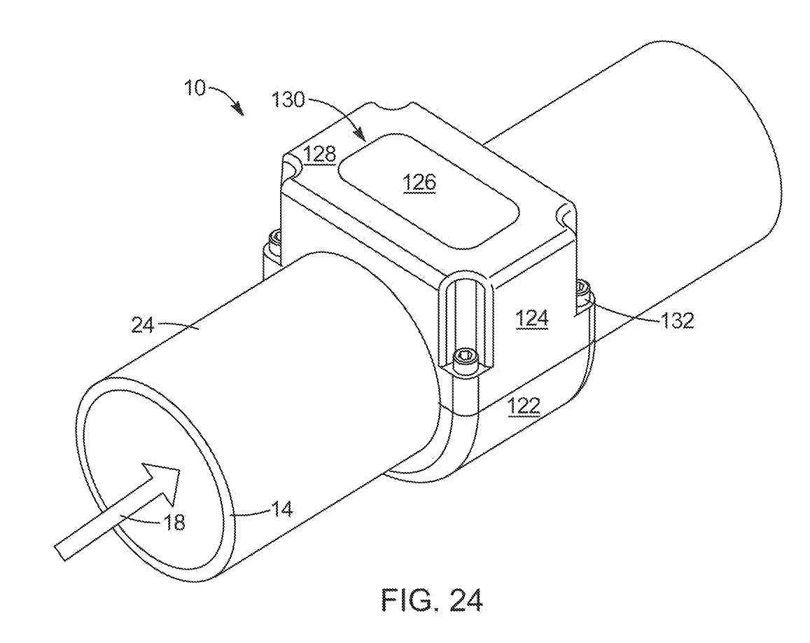

Referring to FIG. 7, while referring generally to FIGS. 3-35, in certain embodiments of an apparatus and method in accordance with the invention, a flow meter 10 may not require any extension 12. For example, placing an extension 12 between the flow meter 10 and the conduit wall 14 provides positioning of the meter 20 or sensor 20 in the free stream of the flow 18. However, in the embodiments of FIGS. 3-4 and 7-35, the sensor 20 may be mounted flush against the wall 14 of a conduit 24. In certain embodiments, for example, a probe 50 may be mounted to have a sensor 52 connected to leads 54 passing through suitable packaging 56 to arrive at the probe 50 in the flow 18.

Referring to FIGS. 7 and 8, while continuing to refer generally to FIGS. 7-35, a probe 50 mounted flush against a face 58 of a mount 60 may provide a radically different approach, from the embodiment of FIGS. 1 and 2. For example, rather than depending on the free stream of the flow 18 passing through the conduit 24, the sensor 52 on the face 58 of the mount 60 places the boundary layer of the flow 18 against the sensor 52. Thus, the probe 50 may measure temperatures and temperature differences in the steepest gradients of the flow and temperature in the boundary layer. Accordingly, a different approach is taken to temperature detection and interpretation, including flow measurement.

In certain embodiments, the mount 60 may include an insert 62 or insert portion 62 that literally fits into an aperture 66 formed in the wall 14 of the conduit 24. Thus, if the face 58 is shaped to fit the interior diameter of the conduit wall 14, then the flange 64 may be used to rotate the insert 62 of the mount 60 in order to orient the shape of the face 58 to be a truly flush continuation of the wall 14 of the conduit 24.

In alternative embodiments, a flat end of a right circular cylinder may serve suitably as the face 58 of the insert portion 62 of the mount 60. Nevertheless, this flat face 58 may pass into the boundary layer of the flow or be recessed from the wall 14. Neither position is as preferable as a flush curvature matching the wall 14.

In certain embodiments, the flange 64 may simply be marked with an arrow indicating the direction of the flow 18 along the length of the conduit 24, making orientation a very simple matter. Thus, the face 58 may be sized, along with diameter of the insert 62, in order to match the internal diameter of the conduit 24 with a flush face 58. In general, the sensor 52 or combined unit 23 is arranged to fit into and be part of the face 58 to minimize flow disruption in the embodiment of FIGS. 7-10.

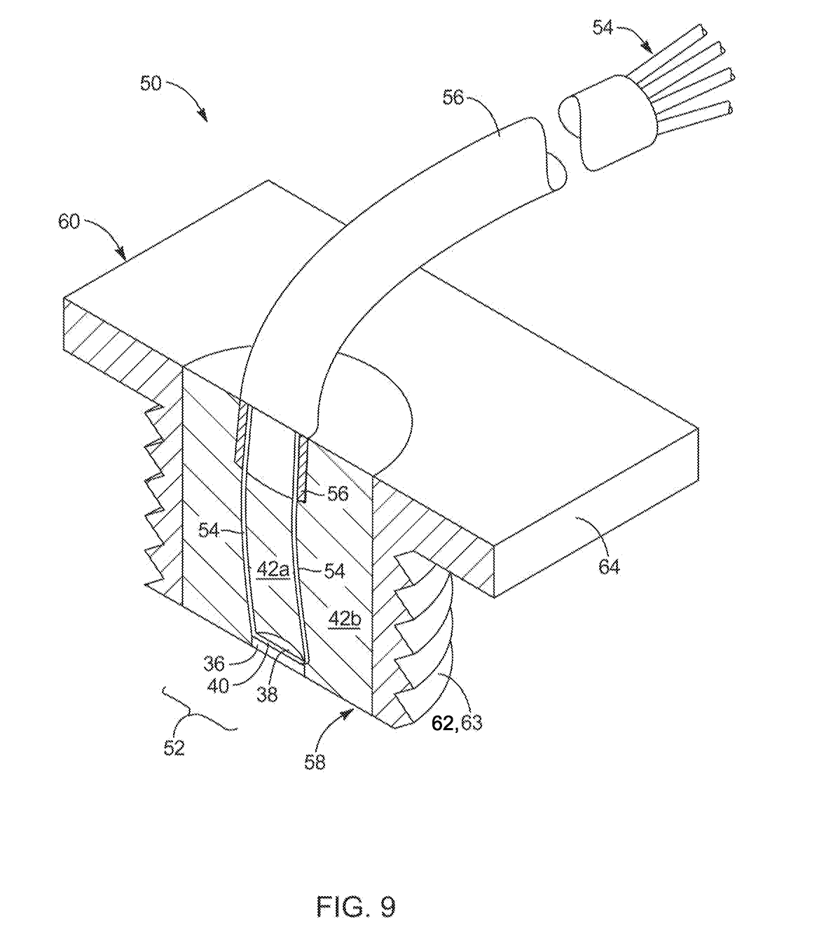

Referring to FIG. 9, a probe 50 may be built within the protection of a mount 60. The probe 50 is typically centered around a sensor 52, typically a unitary sensor and heater 23. The sensor 52 includes a substrate 36, typically of a ceramic material, and formed to be extremely thin. Typically, an electrical film 40 forms the heart of the sensor 52, and in some contexts may be considered the sensor 52. The electrical film 40 is deposited in a long and convoluted path and varies in electrical resistance as a function of temperature. Accordingly, in certain embodiments, a changed (e.g. an increased) temperature in the electrical film 40 causes an increased resistance. In some embodiments of a sensor 52, resistance may decrease with an increase in temperature. However, it has been found effective to use resistance thermal devices (RTDs), wherein resistance increases with temperature. Particularly, in platinum devices, the variation is proportional with temperature and is substantially linear.

In the illustrated embodiment, a seal 38 is formed over the top of the electrical film 40, and bonded to the substrate 36 around the film 40. Typically, the electrical film 40 is connected to leads 54, which leads 54 may be covered and sealed by the seal 38. Thus, substantial protection is provided for the electrical film 40, which is comparatively very thin, on the order of a few microns, and certainly less than a millimeter or even a thousandth of an inch.

The entire sensor 52 with its substrate 36, seal 38, and electrical film 40 is typically potted in a potting material 42 (a trailing letter, as in 42a, indicates a specific instance of the item designated generally by the numeral, as in 42). In some embodiments, the probe 50 is potted in an initial potting material 42a, which is later potted in a second potting material 42b to hold it and seal it into the mount 60.

The mount 60 includes an insert portion 62 and a flange portion 64. The insert portion 62 may include threads 63. In some embodiments, the insert portion 62 may be sealed into a conduit 24 simply by gluing, filling, bonding, or the like. In other embodiments, threads 63 may turn into an aperture in a conduit 24, thereby holding and sealing the mount 60 into the wall 14 of a conduit 24. Typically, the length of the insert portion 62 may be selected such that the flange 64 stops the insert portion 62 from intruding into the lumen 68 of the conduit 24.

A packaging or wrap 56 around the leads 54 may pass out through the potting 42, eventually delivering the leads 54 for connection to the power source 28. In certain embodiments, two leads 54 may be sufficient. In other embodiments, it has been found effective to use four leads 54. Alternative embodiments may use more or fewer leads 54 than these.

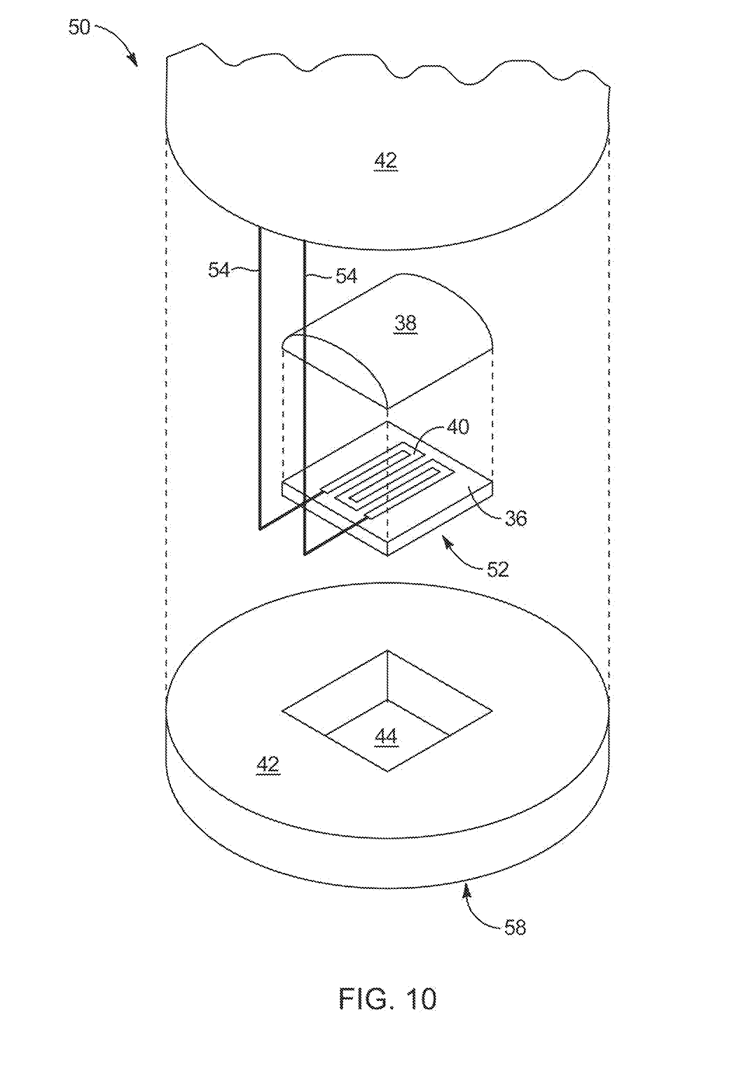

Referring to FIG. 10, in this exploded view of one embodiment, a potting material 42 may be placed around a substrate 36 that has received a foil or electrical film 40 applied thereto in a serpentine path, typically by vapor deposition in a comparatively very thin layer. In the exploded view of FIG. 10, the potting 42 has been opened up in order to show in an exploded view of the substrate 36 with the foil film or electrical element 40 deposited thereon. The film 40 may be arranged in a serpentine path connecting to leads 54. The leads 54 apply a voltage, driving a current through the film 40 to generate heat.

Meanwhile, another source of voltage may apply to the leads 54, driving a different and much lower current, in order to determine the resistance in the film 40. Typically, the substrate 36 will be protected by being placed on a flat surface defining a bottom plane 44. Accordingly, the potting material 42 is not permitted to encroach upon the bottom plane 44 below the substrate 36. In this way, the outer face of the substrate 36 is effectively the bottom plane 44 for the sensor 52 and the probe 50.

The seal 38 is positioned to be formed over the top of the electrical element 40 and the substrate 36, sealing the electrical element 40 and its leads 54 against mechanical or chemical intrusion. The entire stack of the substrate 36, electrical element 40 and seal 38 may then be potted inside a potting material 42. The separation of the potting material 42 into two pieces, never actually occurs, but is simply illustrated here by way of schematically identifying this stack of materials from the bottom plane 44 up through the probe 50.

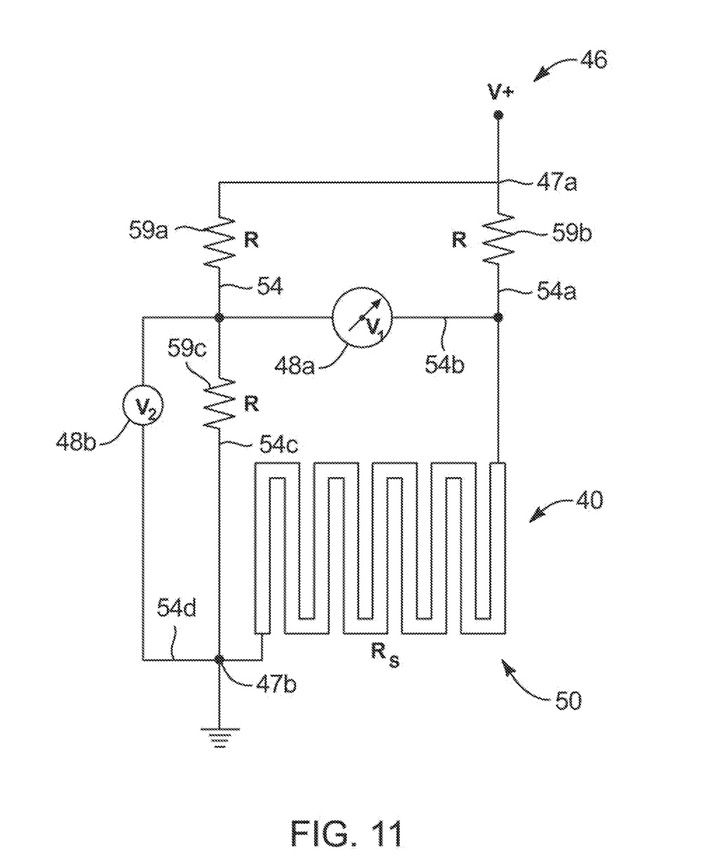

Referring to FIG. 11, the electrical element 40 is connected to the leads 54, which are themselves connected in a bridge. In the illustrated embodiment, the electrical element 40 may be set among other resistors 59 (i.e., 59a, 59b, 59c) that operate to regulate current and determine voltage drops thereacross in order to evaluate the resistance value, and thus temperature, of the electrical element 40.

One advantage of a probe 50 in accordance with this embodiment of a system in accordance with the invention is that the electrical element 40 may be powered by a heating current at the same time it is being probed or tested for its electrical resistance by a second power source.

In a Wheatstone bridge configuration, the electrical element 40 may be placed in a bridge arrangement with other resistors 59 (e.g. 59a, 59b, 59c) that together are powered by a high power source 46 or a sensing power source 46.

Heating is controlled by the high power source 46 driving current through the bridge, and some of that current through the electrical element 40. Meanwhile, a voltage source 46 may drive a voltage through the electrical element 40, thus inducing a current through the electrical element 40 that can be detected by meters 48a, 48b across the electrical element 40. In an alternative embodiment, a single voltage source 28 or power source 28 may suffice. By either mode, the meters 48 may detect the response of the electrical element 40 to temperature, and thus deduce temperature.

In the circuit illustrated for the electrical probe 50, the leads 54 may include various legs or portions 54a, 54b, 54c, 54d, each with its own connections, voltage drop, and so forth. A voltage potential may be applied between the nodes 47a, 47b. Meanwhile, the leads or lines 54a, 54b represent two leads 54 extending from one extreme or one end of the electrical element 40. Likewise, the lines 54c and 54d represent two other leads 54 proceeding from the opposite end of the electrical element 40.

Thus, in the embodiments of FIGS. 7-11 the electrical element 40 may be the only resistance that is actually built into or onto the substrate 36. That is, the remaining lines 54 and resistances 59 illustrated may actually all be somewhere else within the probe 50, outside it, or even in a computer system that will control, read, and monitor the probe 50. Various arrangements of the circuit of FIG. 11 may be made in order to maintain a minimum envelope (e.g. spatial envelope or spatial volume) required in the probe 50 with all other ancillary electrical and electronic equipment elsewhere.

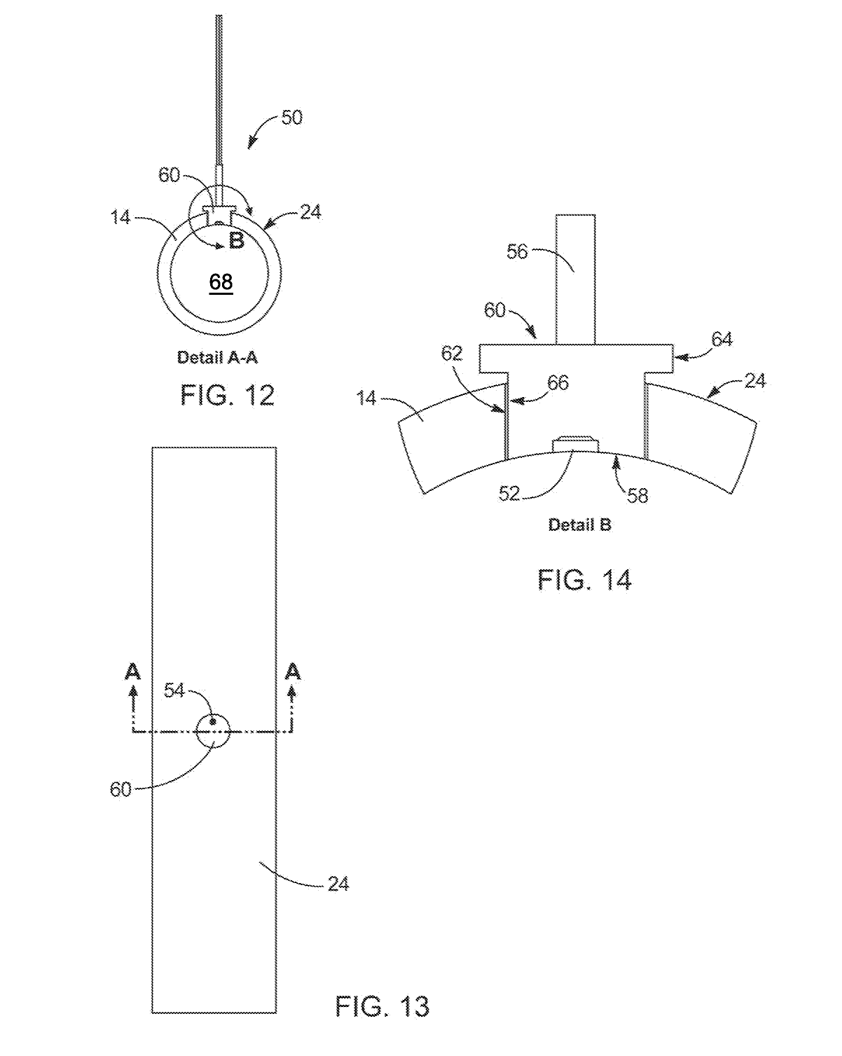

Referring to FIGS. 12-14, while continuing to refer generally to FIGS. 1-35, in certain embodiments, the lumen 68 or passage 68 represents the internal cavity 68 of a conduit 24. This passage 68 may be matched to the diameter and curvature of a face 58 of the insert portion 62 of the mount 60. In such an embodiment, the flange 64 may act as a stop or saddle 64 to register the depth of the insert portion 62 in order to match the thickness of the wall 14 of the conduit 24. Thus, as illustrated, the diameter and curvature of the face 58 of the insert portion 62 of the mount 60 may be fitted to the specific interior diameter of the conduit 24.

The sensor 52 may be any suitable sensor. In one presently contemplated embodiment, thermocouples have served, but RTD sensors have also shown to be very simple to implement. For example, in one embodiment, a four-wire RTD sensor 52 may be used, having one pair of wires providing a known heating current pulse, with the other pair of wires connected to a sensing power supply, voltage meter, or both. Inasmuch as the RTD increases in resistance with the increase of temperature, a resulting sensed voltage is mapped to the temperature to which the sensor 52 is exposed.

Steady-state measurements in the free stream of a flow in a chemical plant may be monitored on a millisecond basis or even more frequently. Typically, a constant output for flow is desirable. Flow correlations may relate a particular total flow rate over time according to the fluid properties, such as viscosity, density, and so forth, of the fluid flowing in a conduit 24.

Correlations are based on the maximum velocity at the center of the conduit 24, or at least in the free stream where the velocity profile is fully developed and understood. Accordingly, reliable data can be taken in the free stream of a flow. From that, the net flow may be calculated from the diameter of the pipe, the roughness of its interior surface, the fluid properties, and so forth. The systems in accordance with the invention may do so, with or without an extension 12 into the flow.

In one present embodiment of an apparatus and method in accordance with the invention, the fluid properties, which ultimately contribute to the temperature of the sensor 52 adjacent to the wall 14 of the conduit 24, vary dramatically, with steep gradients at or near the wall 14, often an order of magnitude change. Nevertheless, it has been found that the transient changes in temperature may still be used to take very rapid measurements.

For example, in certain embodiments, an apparatus and method in accordance with the invention are used to take rare measurements spaced at minutes or even hours apart. Thus, a very low-cost, low-power, and low-maintenance mechanism 50 has been developed for broad distribution. It is cost effective, especially in applications that do not warrant the expensive, continuous, continual, precise measurement systems that are justified by high-volume industrial processes.

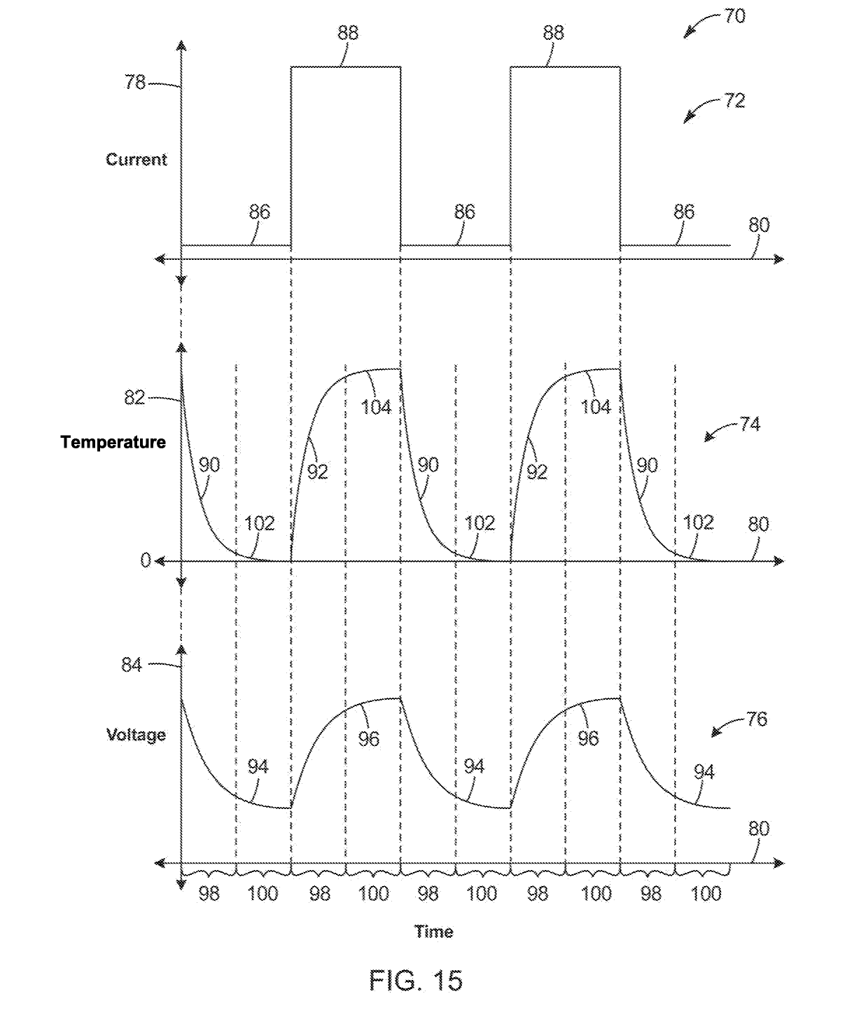

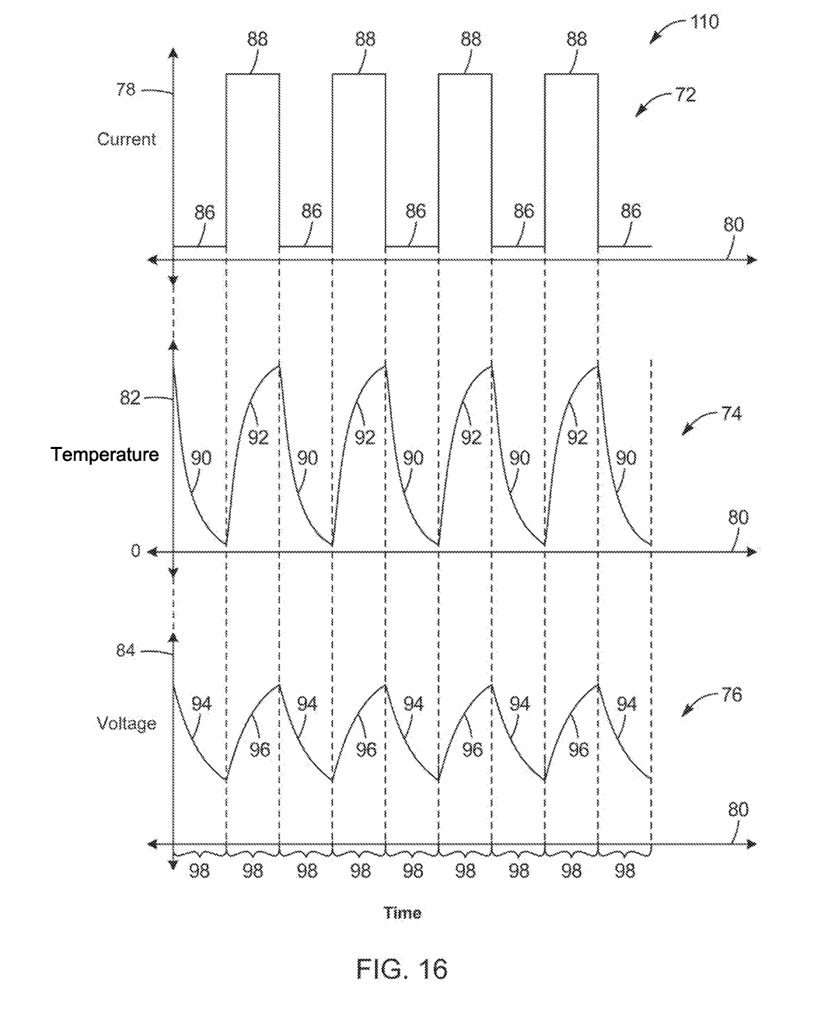

In FIGS. 15 and 16, the plots 70 and 110 illustrate several curves 72, 74, 76. These relate to a current axis 78, a time axis 80, a temperature or temperature difference axis 82, and a voltage axis 84. Thus, we may speak of current 78, time 80, temperature 82, and voltage 84 as represented along their respective axes 78, 80, 82, 84 in the plots 70 and 110.

The curves 72, 74, 76 illustrate current 78, temperature 82, and voltage 84, respectively, as a function of time 80. In the illustrated embodiment, as plotted in the plot 70, a region of low current 86 may represent mere milliamps of current through a sensor 52. For example, tests were run using a low current value of approximately one milliamp.

Meanwhile, the high current region 88, represented in the plots 70 and 110, operates at about 50 milliamps of current. Thus, during a decay portion 90, the temperature 82 decayed, and the corresponding voltage 84 likewise decayed. As a result of the low current 86 that was basically unsubstantial, the resulting decay 90 in temperature and decay 94 in voltage 84 reflected the transient behavior. The fluid in the conduit 24 cools the sensor 52 in the wall 14 of the conduit 24.

The decay 90, 94 may initially pass through a transient region 98. However, at some point, the decay 90, 94 approaches a steady state, identified in the plot 70 as the steady-state region 100. Thus, the voltage 84 reflects the temperature 82 in the steady-state portion 100, providing a comparatively lower value of heating in the low temperature mode of the sensor 52, which may almost zero in some embodiments.

A rise 92 in temperature, with corresponding rise 96 in voltage, may reflect the application of the comparatively higher current 88 in the curve 72 applied to the sensor 52. The rise 92, 96 may initially pass through a transient region 98. However, at some point, the rise 92, 96 approaches a steady state, identified in the plot 70 as the steady-state region 100. Thus, the voltage 84 reflects the corresponding temperature 82 in the steady-state portion 100, the current 88 providing a high value of heating in the high temperature mode of the sensor 52.

A high temperature 104 may be a quasi steady-state temperature 82. Comparing that higher, quasi steady-state temperature 104 with the quasi steady-state lower temperature 102 provides an indication of the velocity of the flow 18 through the lumen or passage 68 of the conduit 24.

One advantage of an apparatus and method in accordance with the invention is that a simple calibration based on the steady-state temperatures 102, 104 and their difference, particularly, can be achieved in a matter of seconds. For example, in one embodiment, it has been found that the transient portion 98 of time 80 need only be from about one half to about two seconds. Typically, a second and a half has proven effective.

Likewise, the steady-state portion 100 or quasi steady-state portion 100, in which comparatively little change occurs in temperature 82 or voltage 84, need only be about the same period of time. Typically, another second to two seconds, at most, will often be adequate to determine the shape of the curve and thus correlate to flow rate. It has been found in certain experiments that two seconds for the quasi steady-state portion 100 has proven entirely adequate for calibration.

One benefit of a system 10 in accordance with the invention is that the probe 50 need only be powered intermittently, and only cycled intermittently. Continuous power as required in conventional anemometers is not necessary. For example, holding a stead state is not required, only enough time to stabilize at a high and a low temperature. Likewise, the cycling need not be repeated continuously. It may be, but need not be. Intermittent, even rare, operation is possible to detect flow rates at any frequency sufficient to determine the flow, where it is substantially continual. Thus lower energy use, rapid-quasi-steady-state measurement conditions, and less frequent duty cycling, and reduced duty cycle are all available to reduce energy costs without loss in accuracy. Meanwhile, no probe 50 need extend into the flow 18, so debris and chemically active fluids need not limit the utility of the probe 50.

Experimental data shows that a quasi steady-state period 100 of a mere second, with transient period 98 of a second and a half, has proven entirely adequate with very light-weight RTD sensors 52 having dimensions of about 2 millimeters square and a millimeter of thickness.

A benefit of the probe 50 as described hereinabove is that the effective mass of the sensor 52 itself is so minuscule in comparison to the flow 18 in the conduit 24, and even of the conduit wall 14 itself, as to render it insignificant as compared with the mass and thermal inertia embodiment of FIGS. 1-6. Thus, the plot 70 reflects the behavior of the inside surface of the wall 14 of the conduit 24, quite directly. Time lags, typical of larger masses, have been found insignificant.

Referring to FIG. 16 and comparing to FIG. 15, it has been found that the steady 10 state portion or quasi steady-state portions 100 may not even be required in some embodiments. For example, the temperature 82 and its voltage 84 resulting in the sensor 52 may rise or have a rise portion 92, 96, followed by a decay portion 90, 94. These may immediately follow one another without any intervening quasi steady-state region 100. Meanwhile, the shape of the rise curves 92, 96, and the decay curves 90, 94, may be matched or fitted through calibration to a particular flow condition. Thus, a look-up table or the like may be set up in order to determine flow rate for any particular fluid.

In this regard, different fluids may be calibrated in lieu of calculating all the theoretical flow parameters that would otherwise be required. In an apparatus and method in accordance with the invention, a particular material, in a particular size of conduit 24, may be represented by plots 70 and 110 to completely characterize the flow 18. The plots 70 or 110 may do so with a very infrequent, low-power, and short duration pulse.

In some embodiments, the testing of flow rate need only occur sporadically in order to obtain an average use rate, such as a home owner's use of culinary water, landscaping irrigation water, or the like. In such embodiments, a measurement taken every minute or every few minutes during a day may adequately test and provide a net average throughout a month or year period.

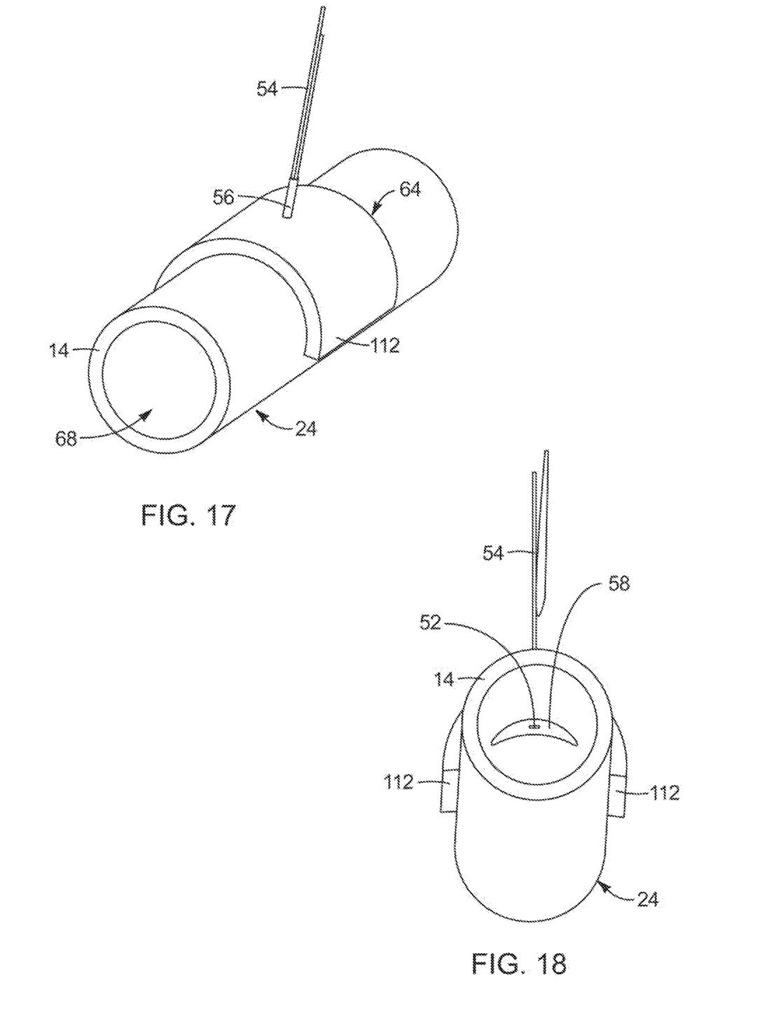

Referring to FIGS. 17-23, while continuing to refer generally to FIGS. 1-35, a flange 64 may be embodied as a semicircular shape providing legs 112 and a saddle 64 in shape. In the illustrated embodiment, the insert 62 may be shaped to match the same size of conduit 24 as the flange 64 or saddle 64 is sized to fit. The face 58 of the insert 62 may be shaped to the inside diameter, while the inner surface of the legs 112 of the flange 64 may be sized to fit the outside diameter of the same conduit 24. The sensor 56 may be placed in intimate contact with the flow 18 through the conduit 24, while the face 58 simply provides the continuing inside surface of the conduit 24 into which the probe 50 has been inserted.

The saddle or flange 64 may be sized to fit the maximum or outside diameter of the conduit 24. In other embodiments, the saddle 64 may actually be sized to wrap around more than 180 degrees of the perimeter of the conduit 24 in order to provide a snap fit. Thus, the saddle or flange 64 may provide for easy assembly and a durable securement while, for example, the glue or solvent sets to permanently fasten or secure and seal the probe 50 to the conduit 24. In such embodiments, installation may be rapid and accurate. Orientation of the face 58 along the surface of the wall 14 of the conduit 24 is simplified.

Referring to FIG. 24, in certain embodiments, the flow meter 10 may be installed in a housing 120. The housing 120 may include a yoke 122 or yoke portion that wraps around at least a part of the conduit 24. Meanwhile, a cap 124 or cap portion 124 may secure to the yoke 122 in order to completely circumscribe or surround the conduit 24. In the illustrated embodiment, a panel 126 may be surrounded by a bezel 128 to form the top of the head 130 above the conduit 24.

By above is meant simply at the location at which the panel 126 may be visible. For example, the panel 126 may include a solar panel that provides electrical power to a battery or other power source inside the head 130 of the housing 120. Likewise, a microprocessor, a radio-frequency communication device, another power source, or the like may all be located within the head 130 of the housing 120. Typically, a housing 120 may be attached with fasteners 132 extending between the yoke 122 and cap 124 in order to permit assembly, retrofitting, repair, replacement, changing of power supplies, or the like.

In certain embodiments, the panel 126 may include a digital display, such as a liquid crystal display (LCD) operating as a very low power display that is easily readable by a meter reader, a user, or the like. Similarly, a radio frequency communication device may be probed by a meter reader either directly from a radio frequency signal output by the flow meter 10 or by a query in the way of an inductive signal imposed upon the housing 120 and resulting in a responsive signal that can then be detected by a reading apparatus of the personnel responsible for meter reading. Likewise, information from such a system may be accessed from a distance and processed by a local, distant, or networked computer system.

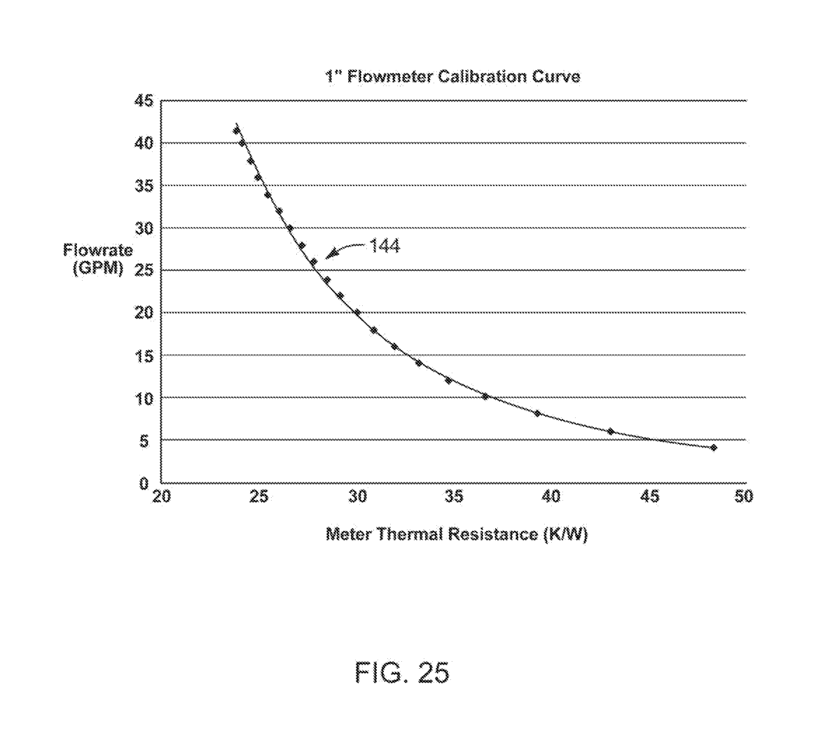

Referring to FIG. 25, in contrast to the embodiment of FIGS. 15 and 16, an exemplary calibration curve 144 is illustrated. The curve 144 correlates flow rate to absolute thermal resistance for a particular flow 18 (e.g., a flow 18 of a particular material or combination of materials in a particular conduit 24 or conduit 24 having a particular diameter). Accordingly, in selected embodiments, changes in temperature 82, heat input, and the like may be used to calculate a thermal resistance for a flow 18. Once the thermal resistance is known, a corresponding flow rate may be identified by referring to the curve 144 or data tables representative thereof.

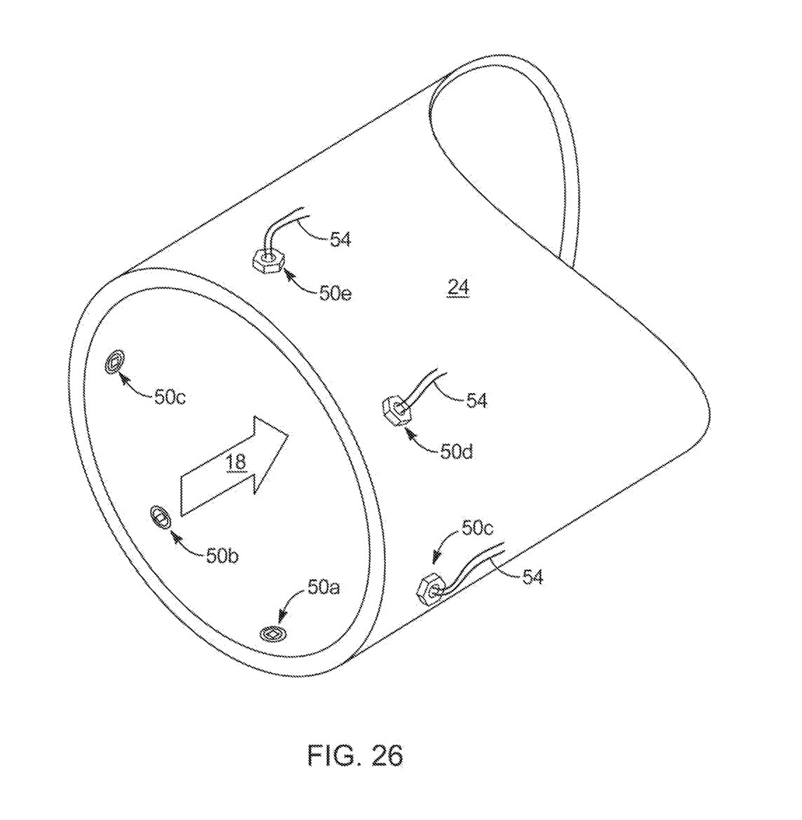

Referring to FIG. 26, a conduit 24 may carry a flow 18. In this embodiment, multiple probes 50 may be installed. In a full conduit 24, any one of the probes 50 may be suitable for measuring the flow rate of the flow 18 passing through the conduit 24. However, the embodiment illustrated provides an ability to determine whether the conduit 24 is completely full, or only partially full. In open systems, including sewers, irrigation systems, ditches, canals, flumes, culverts, and the like, flows may be intermittent, and may not fill the conduit 24. Accordingly, flow correlations for partially-full conduits 24 may used in conjunction with the readings from multiple probes 50 indicating the fill fraction of the conduit 24.

For example, a flow detection by probe 50a, by being wetted, indicates that some flow 18 is passing through the conduit 24. Detection of a flow past the probe 50a but not past the probe 50b indicates a very low flow rate. Similarly, a flow past the probe 50b, but not past the probe 50c indicates a higher level of flow, but not at a rate to fill half the conduit 24. The probes 50c indicate the conduit 24 is at least running half full. Meanwhile, the probes 50d would indicate that flow is nearly full, if the probe 50e is not wetted. Finally, if the probe 50e is wetted, then the conduit 24 is running full.

In certain embodiments, the computer system 10 controlling the power supply 28 may control multiple probes 50a-50e, and shut off probes that do not indicate flow. A temperature excursion that is not reduced properly in accordance with the flow calibrations and correlations will indicate that a probe 50 is dry. Accordingly, any such probe 50 may be shut off and merely tested periodically in order to determine whether flow is passing thereby.

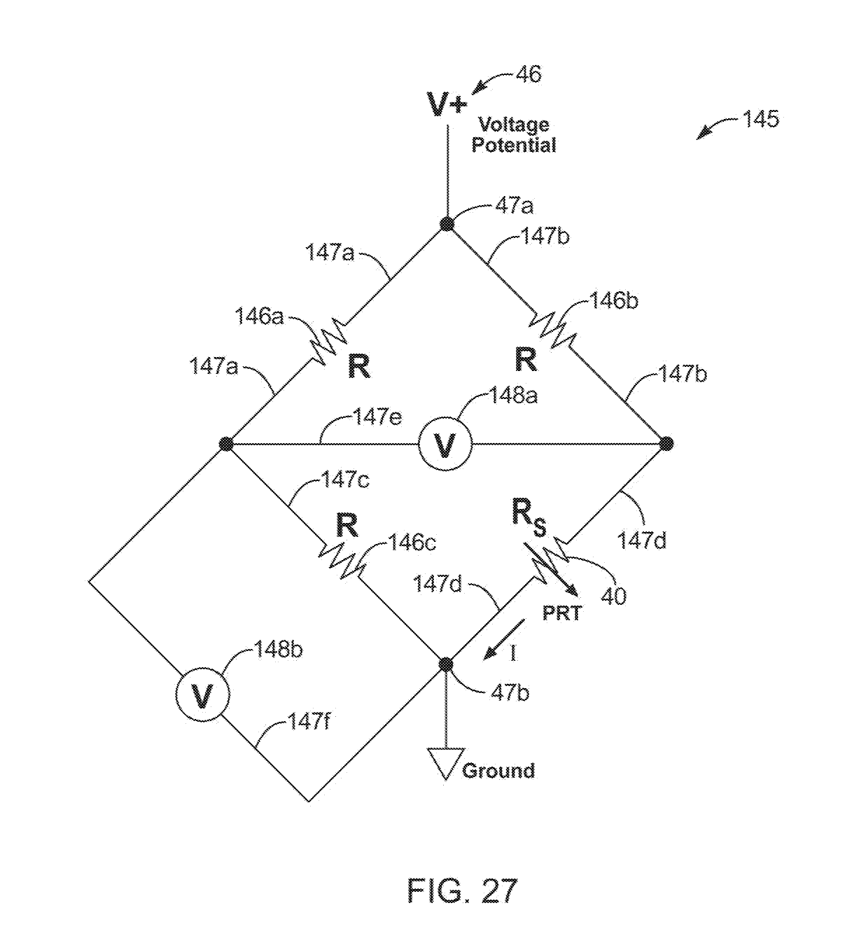

Referring to FIG. 27, a bridge 145 may be made up to include multiple resistors 146 (e.g. 146a, 146b, 146c), one of which is a resistance element 40 operating as a sensor 20 or 52. In the illustrated embodiment, a voltage potential 46 is applied across the bridge 145. Accordingly, a current is induced in each of the lines 147 or legs 147 (e.g. 147a, 147b, 147c, 147d, 147e, 147f).

The current in each respective line 147 depends on the resistance 146, 40 in that particular line 147, as well as the resistance in alternative paths. Thus, the current flowing through the electrical element 40 or the temperature-dependent resistor 40 that operates as a sensor 40 depends on the resistance 146b operating in series with the electrical element 40.

Similarly, the overall current passing between the voltage potential 46 and the ground also has a parallel alternative path through the lines 147a and 147c. Accordingly, the resistances 146a and 146c, affect the division of current between the path through the lines 147b and 147d, as compared with the path through the lines 147a and 147c.

In the illustrated embodiment, a precise measurement of current and voltage needed to determine temperature, based on the current through and voltage across the element 40 may be precisely determined. For example, a voltage meter 148a determines a voltage across the resistors 146c and 40 through the path including the lines 147c and 147d. Meanwhile, the current through the line 147c will be the same as that through line 147d.

The voltage across the meter 148b represents the voltage across the resistance 146c. Accordingly, subtracting the voltage provided by the meter 148b from that read off the meter 148a yields the voltage that must exist across the electrical element 40. Accordingly, both current and voltage, as well as power may be determined (e.g., calculated) through the resistor 40 or electrical element 40 operating as a sensor 20 or 52.

The voltages and currents measured, calculated, or otherwise deduced may be determined by a computer system. Likewise, a computer system connected to any or all of the measurement devices 148a, 148b and the voltage potential 46 applied to the bridge 145 may all be monitored by a computer, processor, or the like. Those to be controlled may be controlled by a computer operably connected to the bridge 145. Computerized control of voltages, currents, and connections may be effected by a computerized control system. Accordingly, software may be developed for implementing the algorithms discussed below.

The computer system, including network connections, storage, processing and the like suitable for hosting control software, monitoring software, power control systems, and all signal processing as well as mathematical manipulations may be hosted in a computer system.

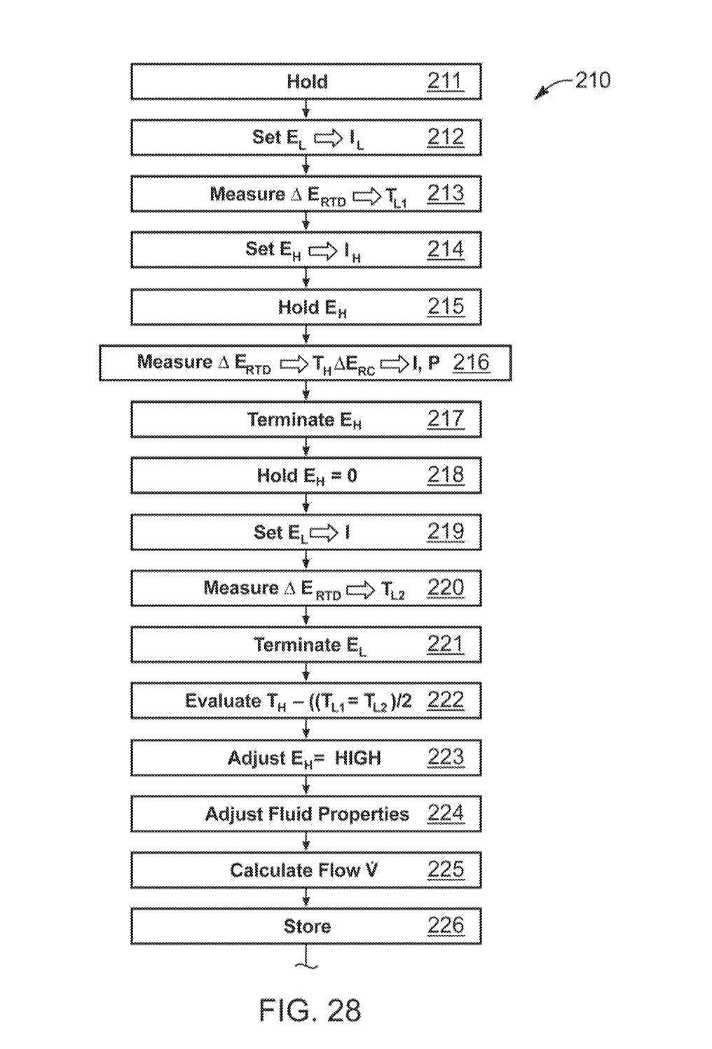

Referring to FIG. 28, a process 210 for measuring flow as a result of a probe 50 in a wall 14 of a conduit 24, may be done by a process 210 that can be repeated on a timely basis. For example, in conventional water pipes, such as those that feed homes and industrial plants, the illustrated procedure 210 has been repeated on a cycle of about ten seconds. The system may be pulsed periodically, and thereby maintain readings, testing periodically to assure that conditions have not changed substantially.

In other embodiments, a system in accordance with the invention may test repeatedly, making one measurement after another almost continuously. It has been found that a cycle of about ten seconds duration has been found suitable. Initially, a process 210 may begin with the system on hold 211. That is, no voltage and no current may be provided to the system 10. On the other hand, a hold 211 may be simply a maintenance on existing conditions.

Initially, setting 212 a potential to a specific value may induce a current. The potential is indicated by a letter “E”, and the current is designated by the letter “I.” At this low value of applied potential (voltage), the measuring 213 across the sensor 50 (e.g. sensor 20, unitary sensor 23, or film electrical element 40) provides a measurement 213 that correlates to the temperature corresponding to the low value of applied potential.

Thereafter, setting 214 a high potential induces a much higher current in the electrical element 40. Accordingly, holding 215 that level of potential causes resistive heating within the probe 50, leading to a rise in temperature of the probe 50, originating with the electrical element 40.

Measuring 216 the voltage or potential across the electrical element 40 indicates the temperature of the electrical element 40 corresponding to the higher potential, with its higher level of current. The change in potential across the electrical element 40 provides a measure of current, power, and resistance, and relates to temperature. Terminating 217 the high level potential, which was a mechanism for inducing a current through the electrical element 40, causes a decay in temperature, and a nearly immediate drop thereof. Holding 218 the high potential at a rate of zero then permits a decay of the temperature of the sensor 40, and indeed the entire probe 50 back to its unpowered equilibrium value.

Following a suitable hold 218, the potential may be set 219 at a low value, corresponding to low potential or low voltage, and a low induced current. Measuring 220 the change in voltage or potential across the sensor 40 provides a reading for a temperature 220 corresponding to the low potential or low power and resistance through the sensor 40. Measuring 213 occurs at substantially the same conditions as measuring 220.

There is the possibility of many situations arising that may affect the temperature at the baseline or equilibrium conditions of the unheated electrical element 40. Accordingly, measuring 213 is a mechanism for determining the initial equilibrium temperature of this sensor 40 before being powered up, whereas measuring 220 is a mechanism for determining the temperature following the power application to the electrical element 40.

Thus, terminating 221 the low level potential permits an evaluation 222 of any temperature rise due to the high power condition, based on an average temperature of the baseline condition before and after the application of higher power. Based on the evaluation, adjusting 223 the high potential may occur. That is, there may be some drift in baseline temperature of the fluid flow 18. Therefore, a different set of operating characteristics may be appropriate.

Likewise, adjusting 224 the values of fluid properties may be important to maintain accuracy of the system 10. Likewise, calculating 225 the flow rate of the flow 18 in the conduit 24 may then occur, by using the equations disclosed hereinafter. Accordingly, storing 226 data may include storing time histories, values of temperature, values of potentials or voltages applied to the probe 50, values of fluid properties, values of flow rates, and so forth. Primary is the flow rate calculated in the conduit 24.

Nevertheless, the conditions under which the flow rate was determined may also be valuable for calibration purposes, modeling, and collecting data for improving operation or design of the system 10. After data has been stored 226, the system may return to a hold 211 to repeat the process 210.

Referring to FIG. 29, a graph 231 represents the performance of the probe 50, and particularly the electrical element 40 of the system 10 in the process 210 of FIG. 28. The graph 231 illustrates a pair of axes 232 and 234. The horizontal axis 232 represents time, and may be measured in any suitable units, typically seconds, as illustrated. Meanwhile, the vertical axis 234 represents temperature, and may be in any suitable temperature scale, typically degrees centigrade.

Initially, a steady state portion 236 on the curve 230 may represent a hold 211 in an unpowered condition, or a low powered or low current condition for testing. The power levels are such that no appreciable heating occurs. Upon setting 212 the low potential, the temperature measurement and thus the flow measurement at the steady state portion 236 may be affected. Thus, measuring 213 determines a temperature, and a flow corresponding to the steady state condition 236 or steady state portion 236.

At a point 238, setting 214 the high potential occurs, resulting in a power-on rise 240 or the rise portion 240 of the curve 230. As long as the high potential that was set 214 in the process 210 continues or is held 215, the rise portion 240 continues to rise or eventually come to some new equilibrium value.

When the heat loss into the fluid comes to equilibrium with the heat gain of the probe 50, then the point 242 indicates that the steady state for a high-power value has been achieved. Thus, the steady state portion 244 indicates a high-power steady-state condition, such as would exist during the hold 215 and consequent measuring 216 of the process 210.

After a suitable time for achieving the steady state portion 244 and taking the measurement 216, termination 217 corresponds to the point 246 on the curve 230. A precipitous decay portion 248 results as the probe 50 cools to the new equilibrium value 252, achieving an eventual steady state at the point 250. Thus, the hold 218 corresponds to the achieving of a steady state between the point 246, and the point 251.

At some point 250, the temperature of the probe 50, and particularly the electrical element 40 achieves a steady-state temperature corresponding to the steady-state portion 252 of the curve 230. At some point during the steady-state portion 252, the system sets 219 a value of low potential, measuring 220 the effective resistance and corresponding temperature of the electrical element 40.

Finally, terminating 221 the testing may occur, for example at the location 251 on the curve 230. Thereafter, the evaluating 222, adjusting 223, adjusting 224, calculating 225, and storing 226 may occur either in real time, or offline, or simultaneously with the steady-state portion 252 of the curve 230.

In general, a thermal flow meter 10 converts temperature and power measurements from a single electrical element 40, such as a resistive temperature device (RTD) or a platinum resistive thermometer (PRT) into a volumetric flow rate measurement. This is accomplished by periodically heating the electrical element 40 and monitoring its temperature response. The temperature response is then converted to a flow rate through a set of empirically derived correlations.

Typically, the flow measurement process 210, as illustrated in the graph 231, takes place over about a ten second cycle, and may repeat about every ten seconds. The temperature of the electrical element 40 during the typical measurement cycle is shown to scale in FIG. 29. The holds 211, 215, 218 may provide an ability for the temperature of the electrical element 40 in the probe 50 to stabilize to its existing equilibrium conditions and achieve a steady-state condition.

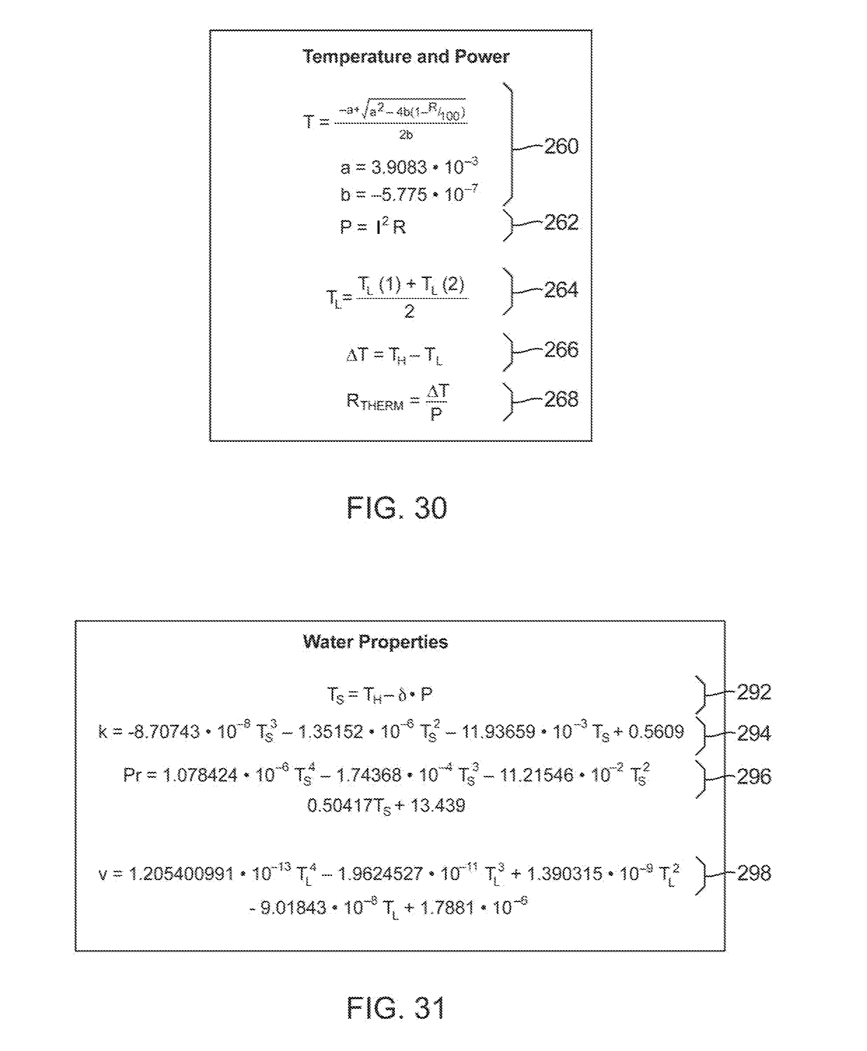

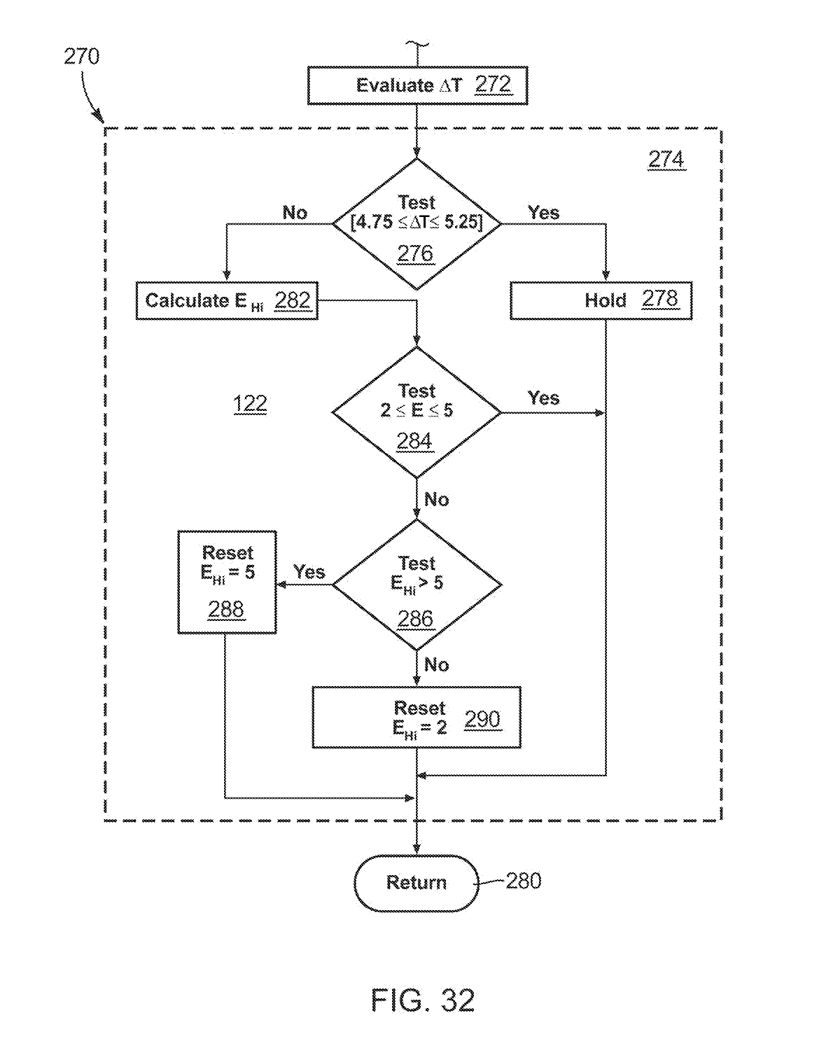

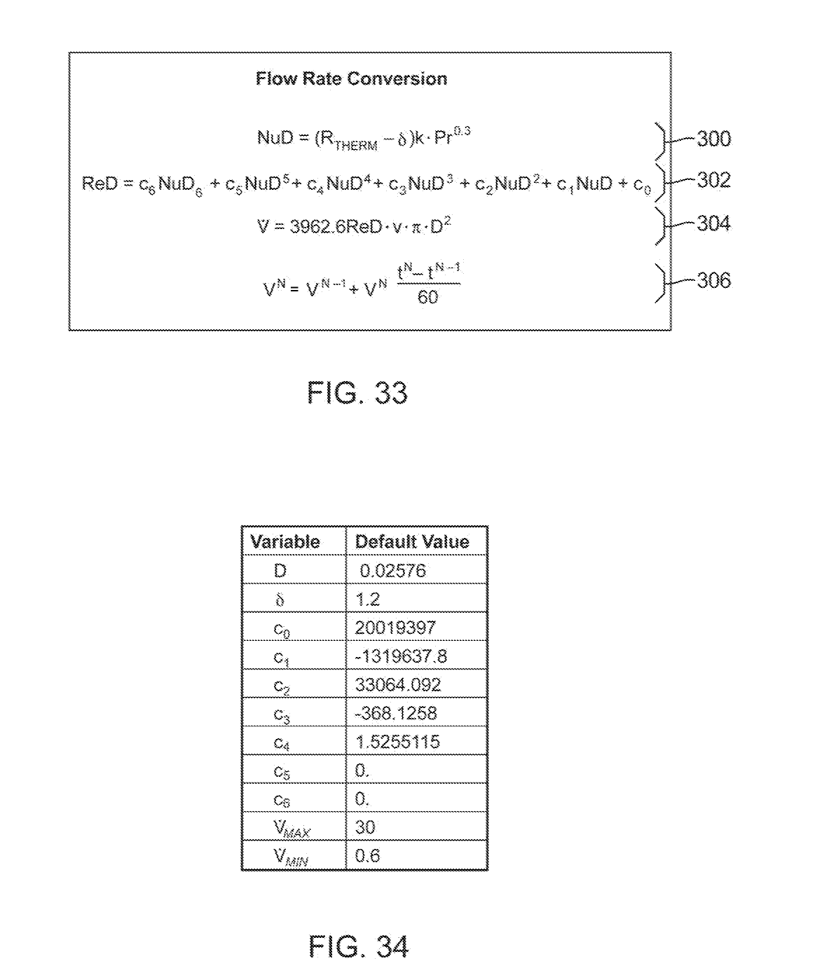

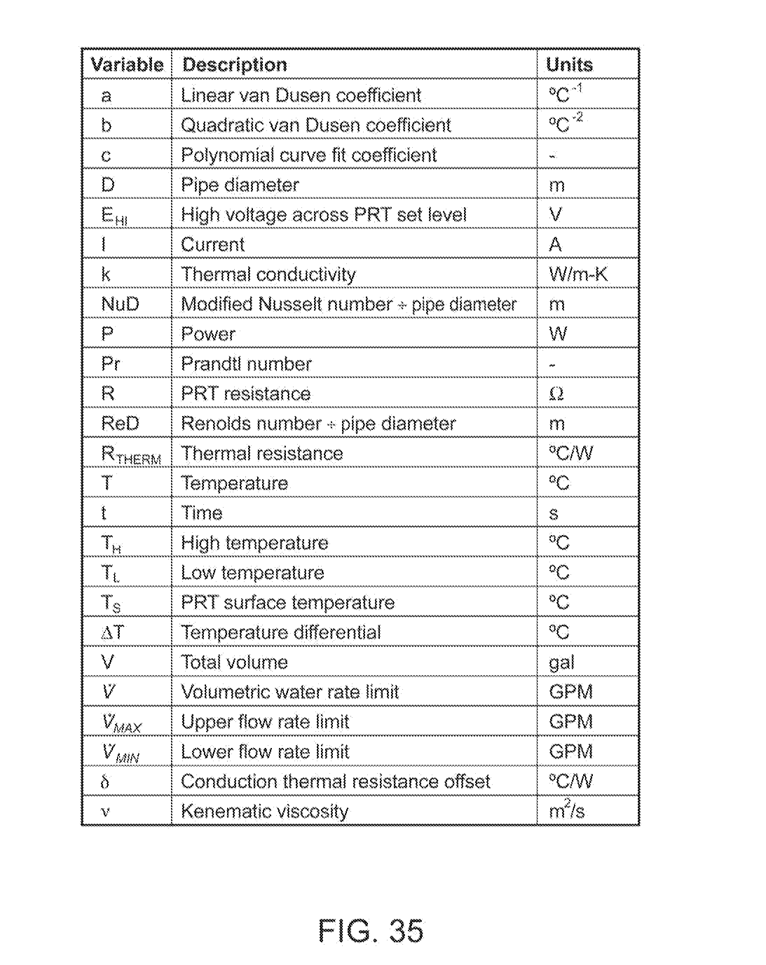

Referring to FIG. 30, the table illustrated identifies the temperature measurement values in the equations 260. The power equation 262 is simply the conventional current squared times resistance through the electrical element 40. Meanwhile, the temperature equation 264 is the base level equation for temperature that will be used at the lower, unheated, power condition. It amounts to an average between the unheated temperature values before and after the power curve portion 240 of FIG. 29 (e.g., steady-state portions 236 and 252). The power curve portion 240 corresponds to the rise initiated by setting 214 the potential to a high voltage and thus high current through the electrical element 40.

The temperature differential is simply the difference between the high temperature value in the steady state portion 244, less the average temperature indicated by the equation 264. This is described in the equation 266. An average of the temperatures during the initial steady state portion 236, and the final steady state portion 252 are averaged by the equation 264, and used in the equation 266. Thus, the thermal resistance is equal to the change in temperature as calculated by equation 266, divided by the power, as illustrated in equation 268.

A thermal flow meter 10 in accordance with the invention may rely on a single resistive temperature device, such as a PRT (Platinum Resistance Thermometer) to make its measurements. The resistance in the electrical element 40 changes temperature nearly linearly, if of the platinum type. Thus, temperature as a function of resistance is related by a single constant over a specific operational range set for a PRT. Upon measuring the resistance in a PRT, the resistance may be converted to temperature using the equation 260.

Meanwhile, the power dissipated by the electrical element 40 is the power put into it, according to the equation 262. Thus, the two low temperature measurements taken during the steady state portions 236, 252 may be averaged by the equation 264 in order to provide a single temperature to be compared against the high temperature corresponding to the steady state 244, in equation 266. Thus, the thermal resistance or the resistant to the transfer of heat may be characterized by equation 268 comparing the change in temperature divided by the power dissipated.

Referring to FIG. 31, water properties may be evaluated as functions of temperature for each measurement cycle. Water properties that are typically calculated include thermal conductivity, indicated by a “k,” kinematic viscosity indicative by the Greek NU (ν), and the non dimensional Prandtl number. The thermal conductivity in the Prandtl number may be evaluated at the surface temperature as defined by the equation 292. Kinematic viscosity is evaluated at the low temperature or the baseline temperature illustrated in FIG. 29 (e.g., the temperature at steady-state conditions 236 and 252), and described in the equation 298. Accordingly, the thermal conductivity is calculated according to the equation 294 while the Prandtl number is described in equation 296. These equations 292-298 represent correlations from fitting the tabularized values of these fluid properties for water as they vary with temperature.

Referring to FIG. 32, the drift in temperature of the flow 18 in the conduit 24 may necessitate updating the properties of the flow 18, which may typically be water-based in many applications. Nevertheless, the flow 18 may be any material, in liquid or gas phase, and may be clean, dirty, debris-laden, or the like.

Initially, the change in temperature or delta T is evaluated 272. Thereafter, a process 270 progresses to a test 276 that determines whether or not the change in temperature is greater than 4.75 degrees or less than 5.25 degrees. This has been found to be a suitable range for operation of sensors 52 in accordance with the invention. If the change in temperature is within range, then the test 276 receives an affirmative result.

That “yes” causes a hold 278 of the potentials, electrical potentials, voltages applied during powering of the temperature rise portion 240 of the curve 230. That is, the value will be maintained.

If on the other hand, the test 276 results in negative results, then the temperature difference between the high and low values is out of the expected range. That is, the difference between the temperature at the steady state 244 and the temperature at the steady states 236, 252 is greater than 5.25 degrees, or less than 4.75 degrees. Therefore, recalculating a new high potential is called for.

Updating fluid flow properties may then require testing where the potential is greater than or equal to two volts, and less than or equal to five volts. If the potential is within this range, then again the process 270 may go onto the return 280. Just as the hold 278 indicated maintaining the value of the high potential, the test 284, if answered affirmatively, results in a return 280 to the system 10 using the high potential value on which it operates.

Nevertheless, a negative outcome of the test 284 requires a test 286 to determine if the potential is out of range on the high side. If so, then a reset 288 truncates the value of the high potential, and fixes it at a five-volt increase. In this way, the high potential is effectively stabilized against overly large excursions. Likewise, a negative result to the test 286, indicates that the potential has changed less than two volts, and is therefore reset at a fixed value of two volts.

Following each of these resets 288, 290, whichever applies, results in a return 280 to the process 210. In order to provide a power level to a probe 50, such as the electrical element 40, and specifically a PRT, as used in certain experiments in accordance with the current invention, a high voltage level is detected across the PRT. This is not across the bridge in which it is connected, but through the PRT itself that it is evaluated after each measurement cycle and adjusted as appropriate.

The goal of the high voltage (potential, E) adjustment is to maintain a temperature difference of about five degrees between high and low power conditions in the probe 52 (element 20 40). One reason for this temperature difference is that it has been found much more straightforward to measure temperatures at the steady state conditions 236, 244, 252 rather than try to determine the shape of the rise curve 240 or the rise portion 240 of the temperature curve 230.

For example, note the asymptotic approach of the curve 230 as the rise portion 240 approaches the point 242 at which steady state exists. Similarly, observe the decay portion 248 of the curve 230 as the temperature drops off to a new steady state condition achieved at the point 250. Determining exactly how close the temperature is to a steady state is much more difficult than simply determining what the value is at the steady state.

That is, trying to measure the very small difference between a temperature of the curve 230, and a steady state value 244, 252 or its time of occurrence is much more difficult and unclear than simply evaluating the temperature at the steady state 244, 252. Thus, measuring the time to achieve steady state is much more difficult, and fraught with the errors associated with localized turbulence. Instead a simple temperature measurement may be made after the temperature has clearly achieved a steady state.

Thus, the high-voltage adjustment may be made in the process 270 in order to maintain the temperature differential between the minimum value of the steady-state temperature, 236 and 252, and the maximum value of the steady state temperature 244. Thus, the process 270 may be used to adjust the high voltage set point. An initial value of two volts may be used, and a maximum voltage of five volts is typically permitted.

Referring to FIG. 33, a table of equations provides the description of parameters used for the conversion from temperature to flow rate. Temperature and power measurements are used to calculate a flow rate in a conduit. Initially, a modification of the Nusselt number (Nu) is calculated by using the equation 300, where the variables and coefficients are defined in FIG. 34. Initially, the modified Nusselt number (NuD) is not the Nusselt number multiplied by diameter, but the Nusselt number divided a significant length, which would otherwise be included in the dimensional Nusselt number. The result is a dimensionalized number having units of inverse length.

This modified Nusselt number is converted to a flow Reynolds number by using a polynomial curve fit found in the equation 302. Again, this is a modified Reynolds number, and does not represent the Reynolds number multiplied by a significant length or diameter, but rather corrected to remove the diameter as a significant length. Thus, the modified Reynolds number (ReD) represents the Reynolds number divided by diameter. Thus, the modified Reynolds number of equation 302 is found by a sixth degree polynomial curve fit relying on the modified Nusselt number and the coefficient as outlined in the table of Figure

Ultimately, the volumetric flow rate is defined in equation 304, and is described in gallons per minute of flow through the conduit 24. The units are corrected for by the leading coefficient. Also, FIG. 35 provides a description of each of the parameters, with the dimensions of each. Accordingly, the instantaneously flow rate over any measurement interval is described in equation 306. Thus, equation 304 provides the instantaneous flow rate, while the equation 306 provides the net, integrated, total volume transported over any period of time observed. Thus, in general, a water meter may measure volumetric flow rate, but is usually in place for purposes of calculating a net total volume of water. This outcome is provided by the equation 306.

Referring to FIG. 34, the variables that influence the calculation of the modified Reynolds number of equation 302 may be modified according to the equations in previous tables of FIGS. 30 and 31, and the process 270 of FIG. 32. Likewise, the principal procedure 210 or method 210 results in the adjusting 224 of fluid properties. Accordingly, the values of the variables of FIG. 34 may change. Nevertheless, default values have been prepared. Accordingly, the table of FIG. 34 identifies starting values, which may then be adjusted according to the actual properties determined, based on the actual temperatures detected.

Referring to FIG. 35, a table presents various variables for the equations used in calibrating, updating, and calculating in accordance with the invention. Accordingly, a description of each variable, along with its symbol is shown beside the dimensions or units in which each is measured.

The present invention may be embodied in other specific forms without departing from its fundamental functions or essential characteristics. The described embodiments are to be considered in all respects only as illustrative, and not restrictive. All changes which come within the meaning and range of equivalency of the illustrative embodiments are to be embraced within their scope.

What is claimed is:

1. A flow meter comprising:
a probe configured to fit in an aperture of a conduit, the conduit configured to transmit a fluid flow and having a flow-side surface;
a temperature sensor configured to measure a first steady-state temperature of the probe;
a heating element configured to heat the probe to a second steady-state temperature of the probe; and
a processor configured to calculate a rate of the fluid flow as a function of the first and second steady-state temperatures.

2. The flow meter of claim 1, further comprising:
a boundary layer at the flow-side surface; and
wherein the probe is located in the boundary layer.

3. The flow meter of claim 1, wherein the probe has a probe surface and the probe surface and the flow-side surface of the conduit form a flow surface that is substantially smooth and continuous.

4. The flow meter of claim 1, further comprising:
a plug with the probe embedded therein, the plug having a plug face; and
wherein the plug face is contiguous and continuous with the flow-side surface across the aperture.

5. The flow meter of claim 4, wherein:
the plug forms part of a mount and the mount has an indicator showing a location of the plug face relative to the flow-side surface; and
the probe is located such that the indicator shows the location of the plug face as contiguous and continuous with the flow-side surface.

6. The flow meter of claim 1, further comprising:
a current configured to measure the probe temperature and heat the probe to the second steady-state temperature.

7. The flow meter of claim 1, wherein:
the temperature sensor is configured to measure a transient temperature of the probe as the probe is heated; and
the processor is configured to correlate a time to the transient temperature and calculate the rate of the fluid flow as a function of the transient temperature and time.

8. The flow meter of claim 1, wherein:
the temperature sensor and the heating element is a thin-film resistive temperature device.

9. The flow meter of claim 1, further comprising a current effective to provide an indication of a probe temperature and maintain the probe temperature effectively at an unheated temperature.

10. A flow meter, comprising:
a probe configured to fit in an aperture of a conduit, the conduit having a flow-side surface and configured to transmit a fluid flow;
a temperature sensor configured to measure a probe temperature;
a heating element configured to pulse heat the probe over a time period in response to a current flow through the probe; and
a processor configured to calculate a rate of the fluid flow as a function of the probe temperature, the current flow, and the time period.

11. A method comprising:
providing a fluid flow in a conduit, the conduit having a flow-side surface;
locating a probe in the fluid flow, the probe having an electrical connection effective to measure a probe temperature;
measuring a first steady-state temperature of the probe;
heating the probe to a second steady-state temperature;
measuring the second steady-state temperature of the probe; and
calculating a rate of fluid flow as a function of the first and second steady-state temperatures.

12. The method of claim 11, wherein:
the fluid flow forms a boundary layer at the flow-side surface; and
locating the probe in the fluid flow comprises locating the probe in the boundary layer.

13. The method of claim 12, wherein the probe has a probe surface and the probe surface and the flow-side surface form a flow surface that is substantially smooth and continuous.

14. The method of claim 11, further comprising:
providing an aperture in the conduit;
providing a plug with the probe embedded therein, the plug having a plug face; and
wherein the plug face is contiguous and continuous with the flow-side surface across the aperture.

15. The method of claim 4, wherein:
the plug forms part of a mount and the mount has an indicator showing a location of the plug face relative to the flow-side surface; and
locating the probe in the fluid flow comprises positioning the probe such that the indicator shows the location of the plug face as contiguous and continuous with the flow-side surface.

16. The method of claim 11, wherein:
heating the probe to the second steady-state temperature comprises passing a current through the probe, the current effective to measure the probe temperature and heat the probe to the second steady-state temperature.

17. The method of claim 16, further comprising:
measuring a temperature rise profile as the probe is heated to the second steady-state temperature; and
calculating the rate of fluid flow as a function of the temperature rise profile.

18. The method of claim 1, further comprising:
cooling the probe from the second steady-state temperature to a cooler temperature;
measuring a temperature decay profile as the probe cools; and
calculating the rate of fluid flow as a function of the temperature decay profile.

19. The method of claim 11, wherein a resistance temperature device is configured to self-heat and measure the temperature of the probe in response to a current flowing through the probe.

20. The method of claim 11, wherein measuring the first steady-state temperature of the probe comprises passing a current through the probe, the current configured to provide an indication of the probe temperature and maintain the probe temperature effectively at an unheated temperature.
